(19) United States
(12) Patent Application Publication
(10) Pub. No.: US 2024/0397568 A1
(43) Pub. Date: Nov. 28, 2024

(54) MANAGING A GROUP OF WI-FI-ENABLED WEARABLE OR HANDHELD WIRELESS DEVICES USING A SHARED ADDRESS

(71) Applicant: QUALCOMM Incorporated, San Diego, CA (US)

(72) Inventors: Srikant KUPPA, Fremont, CA (US); Ahmed Ragab ELSHERIF, San Jose, CA (US); Joel LINSKY, San Diego, CA (US); Vincent Knowles JONES, Redwood City, CA (US)

(21) Appl. No.: 18/363,640

(22) Filed: Aug. 1, 2023

Related U.S. Application Data
(60) Provisional application No. 63/504,187, filed on May 24, 2023.

(51) Int. Cl. H04W 76/15; H04W 28/02; H04W 72/12

(52) U.S. Cl. CPC H04W 76/15; H04W 28/0268; H04W 72/12

(57) ABSTRACT

This disclosure provides methods, components, devices and systems for managing a group of Wi-Fi-enabled wearable or handheld wireless devices using a shared address. Some aspects more specifically relate to a negotiation of a shared address that corresponds to a group of Wi-Fi-enabled wearable or handheld devices and use of the shared address during a connection setup procedure for the group. In some implementations, by performing the connection setup procedure using the shared address, one wearable or handheld device may perform the connection setup procedure on behalf of the group. Wearable or handheld devices of the group also may exchange packets to indicate, with respect to the shared address, respective link identifiers (IDs) uniquely corresponding to each respective wearable or handheld device of the group, which the wearable or handheld devices of the group may use to differentiate traffic intended for different wearable or handheld devices of the group.

### CROSS REFERENCE

The present application for patent claims the benefit of U.S. Provisional Patent Application No. 63/504,187 by KUPPA et al., entitled “MANAGING A GROUP OF WI-FI-ENABLED WEARABLE OR HANDHELD WIRELESS DEVICES USING A SHARED ADDRESS,” filed May 24, 2023, assigned to the assignee hereof, and expressly incorporated by reference in its entirety herein.

### TECHNICAL FIELD

This disclosure relates to wireless communication and, more specifically, to managing a group of Wi-Fi-enabled wearable or handheld wireless devices using a shared address.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some systems, a group of Wi-Fi-enabled wearable devices may deliver or otherwise be associated with a same application. Such a group of Wi-Fi-enabled wearable devices delivering a same application may include wireless earbuds, wireless accessories (such as a watch, a bracelet, and/or a ring), health monitors, and/or gaming sensors or controllers. For example, two wireless earbuds may deliver audio data for a same music application. As another example, two or more gaming sensors and/or controllers may deliver input data (associated with motion and/or controller inputs) for a same video game application. Because each Wi-Fi device generally has its own unique medium access control (MAC) address, each device of a group of Wi-Fi-enabled wearable devices typically performs an independent connection setup procedure to connect with a WLAN. For example, a first wearable device may exchange a first set of frames with a handset, AP, or compute device as part of a first connection setup and a second wearable device may independently exchange a second set of frames with the handset, AP, or compute device as part of a second connection setup. As such, the handset, AP, or compute device may independently provision the first wearable device and the second wearable device with Wi-Fi and internet protocol (IP) connections for subsequent data communication.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication at a first wearable or handheld wireless device. The method may include communicating, with at least a second wearable or handheld wireless device via a first wireless communication link, one or more first packets associated with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device, transmitting, in association with establishing a second wireless communication link with a wireless communication device, one or more second packets indicating the shared address, the first link identifier, and the second link identifier, and receiving, from the wireless communication device via the second wireless communication link, one or more third packets associated with the first link identifier.

Another innovative aspect of the subject matter described in this disclosure can be implemented at a first wearable or handheld wireless device. The first wearable or handheld wireless device may include a processing system that includes processor circuitry and memory circuitry that stores code. The processing system may be configured to cause the first wearable or handheld wireless device to communicate with at least a second wearable or handheld wireless device via a first wireless communication link, one or more first packets associate with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device, transmit, in association with establishing a second wireless communication link with a wireless communication device, one or more second packets indicating the shared address, the first link identifier, and the second link identifier, and receive, from the wireless communication device via the second wireless communication link, one or more third packets associated with the first link identifier.

Another innovative aspect of the subject matter described in this disclosure can be implemented at a first wearable or handheld wireless device. The first wearable or handheld wireless device may include means for communicating, with at least a second wearable or handheld wireless device via a first wireless communication link, one or more first packets associated with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device, means for transmitting, in association with establishing a second wireless communication link with a wireless communication device, one or more second packets indicating the shared address, the first link identifier, and the second link identifier, and means for receiving, from the wireless communication device via the second wireless communication link, one or more third packets associated with the first link identifier.

Another innovative aspect of the subject matter described in this disclosure can be implemented in a non-transitory computer-readable medium storing code for wireless communication at a first wearable or handheld wireless device. The code may include instructions executable by one or more processors individually or collectively to communicate, with at least a second wearable or handheld wireless device via a first wireless communication link, one or more first packets associate with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device, transmit, in association with establishing a second wireless communication link with a wireless communication device, one or more second packets indicating the shared address, the first link identifier, and the second link identifier, and receive, from the wireless communication device via the second wireless communication link, one or more third packets associated with the first link identifier.

Another innovative aspect of the subject matter described in this disclosure can be implemented in a method for wireless communication at a first wearable or handheld wireless device. The method may include communicating, with at least a second wearable or handheld wireless device via a first wireless communication link, one or more first packets associated with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device and receiving, from a wireless communication device via a second wireless communication link, one or more second packets associated with the first link identifier, the second wireless communication link being in association with an establishment using the shared address.

Another innovative aspect of the subject matter described in this disclosure can be implemented at a first wearable or handheld wireless device. The first wearable or handheld wireless device may include a processing system that includes processor circuitry and memory circuitry that stores code. The processing system may be configured to cause the first wearable or handheld wireless device to communicate, with at least a second wearable or handheld wireless device via a first wireless communication link, one or more first packets associate with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device and receive, from a wireless communication device via a second wireless communication link, one or more second packets associated with the first link identifier, the second wireless communication link being in association with an establishment using the shared address.

Another innovative aspect of the subject matter described in this disclosure can be implemented at a first wearable or handheld wireless device. The first wearable or handheld wireless device may include means for communicating, with at least a second wearable or handheld wireless device via a first wireless communication link, one or more first packets associated with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device and means for receiving, from a wireless communication device via a second wireless communication link, one or more second packets associated with the first link identifier, the second wireless communication link being in association with an establishment using the shared address.

Another innovative aspect of the subject matter described in this disclosure can be implemented in a non-transitory computer-readable medium storing code for wireless communication at a first wearable or handheld wireless device. The code may include instructions executable by one or more processors individually or collectively to communicate, with at least a second wearable or handheld wireless device via a first wireless communication link, one or more first packets associate with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device and receive, from a wireless communication device via a second wireless communication link, one or more second packets associated with the first link identifier, the second wireless communication link being in association with an establishment using the shared address.

Another innovative aspect of the subject matter described in this disclosure can be implemented in a method for wireless communication at a wireless communication device. The method may include receiving, in association with establishing a wireless communication link with a first wearable or handheld wireless device, one or more first packets indicating a shared address corresponding to an association of wearable or handheld wireless devices including at least the first wearable or handheld wireless device and a second wearable or handheld wireless device, a first link identifier corresponding to the first wearable or handheld wireless device, and a second link identifier corresponding to the second wearable or handheld wireless device and transmitting, in accordance with the shared address, one or more second packets associated with the first link identifier and one or more third packets associated with the second link identifier.

Another innovative aspect of the subject matter described in this disclosure can be implemented at a wireless communication device. The wireless communication device may include one or more memories storing processor-executable code and one or more processors coupled with the one or more memories and individually or collectively operable to execute the code. The one or more processors may be individually or collectively operable to execute the code to cause the first wearable or handheld wireless device to receive, in association with establishing a wireless communication link with a first wearable or handheld wireless device, one or more first packets indicating a shared address corresponding to an association of wearable or handheld wireless devices including at least the first wearable or handheld wireless device and a second wearable or handheld wireless device, a first link identifier corresponding to the first wearable or handheld wireless device, and a second link identifier corresponding to the second wearable or handheld wireless device and transmit, in accordance with the shared address, one or more second packets associated with the first link identifier and one or more third packets associated with the second link identifier.

Another innovative aspect of the subject matter described in this disclosure can be implemented at a wireless communication device. The wireless communication device may include means for receiving, in association with establishing a wireless communication link with a first wearable or handheld wireless device, one or more first packets indicating a shared address corresponding to an association of wearable or handheld wireless devices including at least the first wearable or handheld wireless device and a second wearable or handheld wireless device, a first link identifier corresponding to the first wearable or handheld wireless device, and a second link identifier corresponding to the second wearable or handheld wireless device and means for transmitting, in accordance with the shared address, one or more second packets associated with the first link identifier and one or more third packets associated with the second link identifier.

Another innovative aspect of the subject matter described in this disclosure can be implemented in a non-transitory computer-readable medium storing code for wireless communication at a wireless communication device. The code may include instructions executable by one or more processors individually or collectively to receive, in association with establishing a wireless communication link with a first wearable or handheld wireless device, one or more first packets indicating a shared address corresponding to an association of wearable or handheld wireless devices including at least the first wearable or handheld wireless device and a second wearable or handheld wireless device, a first link identifier corresponding to the first wearable or handheld wireless device, and a second link identifier corresponding to the second wearable or handheld wireless device and transmit, in accordance with the shared address, one or more second packets associated with the first link identifier and one or more third packets associated with the second link identifier.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example signaling diagram that supports managing a group of Wi-Fi-enabled wearable or handheld wireless devices using a shared address according to some aspects of the present disclosure.

FIGS. 3 and 4 show example process flows that support managing a group of Wi-Fi-enabled wearable or handheld wireless devices using a shared address according to some aspects of the present disclosure.

FIG. 5 shows an example flowchart that supports managing a group of Wi-Fi-enabled wearable or handheld wireless devices using a shared address according to some aspects of the present disclosure.

FIG. 6 shows an example communication timeline that supports managing a group of Wi-Fi-enabled wearable or handheld wireless devices using a shared address according to some aspects of the present disclosure.

FIG. 7 shows an example flowchart that supports managing a group of Wi-Fi-enabled wearable or handheld wireless devices using a shared address according to some aspects of the present disclosure.

FIGS. 8-10 show example XPAN topologies that support managing a group of Wi-Fi-enabled wearable or handheld wireless devices using a shared address according to some aspects of the present disclosure.

FIG. 11 shows a block diagram of an example wireless communication device that supports managing a group of Wi-Fi-enabled wearable or handheld wireless devices using a shared address according to some aspects of the present disclosure.

FIG. 12 shows a block diagram of an example wireless communication device that supports managing a group of Wi-Fi-enabled wearable or handheld wireless devices using a shared address according to some aspects of the present disclosure.

FIGS. 13-15 show flowcharts illustrating example processes that support managing a group of Wi-Fi-enabled wearable or handheld wireless devices using a shared address according to some aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to connection setup procedures and data exchange sequences for wearable devices of a group of Wi-Fi-enabled wearable devices delivering a same or similar application. Some aspects more specifically relate to a negotiation of a shared address that corresponds to a group of Wi-Fi-enabled wearable devices and use of the shared address during a connection setup procedure for the group of Wi-Fi-enabled wearable devices. For example, for a group of Wi-Fi-enabled wearable devices (which may be understood as or equivalently referred to as wearable wireless devices) including a first wearable device and a second wearable device, the first wearable device and the second wearable device may exchange, via a first wireless communication link, one or more packets associated with establishing a shared address that corresponds to an association of (such as a grouping of or set of) the first wearable device and the second wearable device. One of the first wearable device or the second wearable device may then perform a connection setup procedure with a wireless communication device (such as an access point (AP), a handset providing SoftAP functionality, or a compute device) using the shared address. The shared address may be an example of a medium access control (MAC) address or may otherwise be an address usable in place of a MAC address. The connection setup procedure may be associated with establishing a second wireless communication link with the wireless communication device. In accordance with performing the connection setup procedure using the shared address, one wearable device may perform the connection setup procedure on behalf of the group of Wi-Fi-enabled wearable devices (such that other wearable devices in the group of Wi-Fi-enabled wearable devices may refrain from performing a connection setup procedure).

In some examples, the first wearable device and the second wearable device may further exchange the one or more packets to indicate, with respect to the shared address, a first link identifier (ID) corresponding to the first wearable device and a second link ID corresponding to the second wearable device. In such examples, the first wearable device may establish a first block acknowledgment (BA) session in accordance with the shared address and the first link ID and the second wearable device may establish a second BA session in accordance with the shared address and the second link ID. As such, both the first wearable device and the second wearable device may transmit and/or receive packets using the shared address and may determine whether a packet is transmitted to or from the first wearable device or the second wearable device in accordance with a link ID associated with the packet. For example, the first wearable device may receive and decode data packets associated with the first link ID and may refrain from (fully) decoding data packets associated with the second link ID. Likewise, the second wearable device may receive and decode data packets associated with the second link ID and may refrain from (fully) decoding data packets associated with the first link ID.

Particular aspects of the subject matter described in this disclosure can be implemented to realize one or more of the following potential advantages. In some implementations, by establishing a shared address that corresponds to an association of a set of two or more wearable devices, one wearable device may perform a connection setup procedure using the shared address such that other wearable devices of the set can refrain from performing a connection setup procedure, which may reduce connection setup signaling overhead and reduce (re)connection latency by limiting connection setup sequences to one interface. For example, by limiting connection setup sequences to one interface, (re)connection times may be reduced by approximately one-half for a group of two wearable devices (because one of the two wearable devices may refrain from performing a connection setup procedure), by approximately two-thirds for a group of three wearable devices (because two of the three wearable devices may refrain from performing a connection setup procedure), and so on. Further, additional channel access opportunities may become available for other devices in the system in accordance with such a reduction in (re)connection times and (re)connection interfaces, which may alleviate multi-client scheduling and enable denser Wi-Fi systems and/or higher data rates by increasing medium availability through delivery of packets to a single shared address. Moreover, in accordance with establishing a connection on behalf of a group of wearable devices using a shared address, the group of wearable devices may experience timely delivery of data to the group of wearable devices by appearing as a single wireless communication device from a network perspective. For example, an AP may deliver all relevant content to a group of wearable devices in an entirety because the AP may not interrupt service to the group of wearable devices to serve other devices in the system because the group of wearable devices appears as a single wireless communication device. In accordance with reducing connection setup signaling overhead and reducing (re)connection latency, enabling denser Wi-Fi systems and/or higher data rates, and leveraging a shared address to support timely delivery of data, aspects of the described subject matter may be implemented to realize greater reliability, greater spectral efficiency, improved user experience, and greater system capacity, among other benefits.

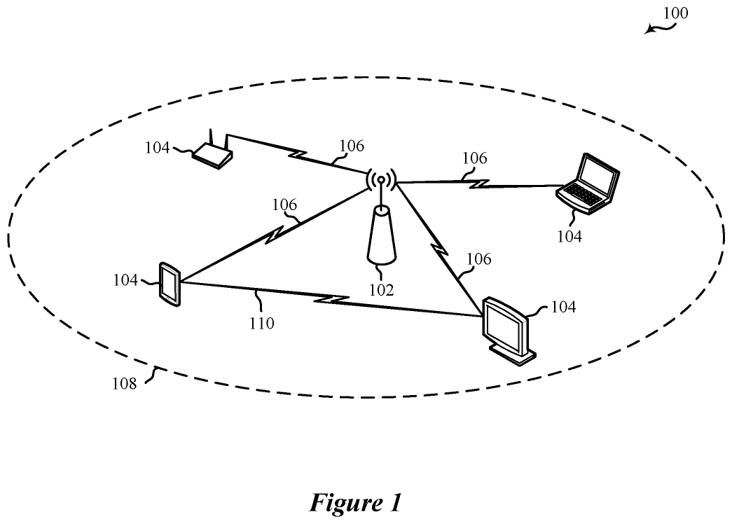

FIG. 1 shows a pictorial diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and 802.11bn). The WLAN 100 may include numerous wireless communication devices such as a wireless AP 102 and multiple wireless STAs 104. While only one AP 102 is shown in FIG. 1, the WLAN 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE or 5G NR) can be further improved by a small cell which is supported by an AP 102 serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (such as TVs (including smart TVs), computer monitors, navigation systems, among others), music or other audio or stereo devices, remote control devices (“remotes”), printers, kitchen appliances (including smart refrigerators) or other household appliances, key fobs (such as for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set ID (SSID), as well as to other devices by a basic service set ID (BSSID), which may be a MAC address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association ID (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communication (hereinafter also referred to as “Wi-Fi communication” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communication. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

Some wireless communication devices (including both APs 102 and STAs 104) are capable of multi-link operation (MLO). In some implementations, MLO supports establishing multiple different communication links (such as a first link on the 2.4 GHz band, a second link on the 5 GHz band, and the third link on the 6 GHz band) between the STA 104 and the AP 102. Each communication link may support one or more sets of channels or logical entities. In some implementations, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MHLD). For example, an AP MLD may include multiple APs 102 each configured to communicate on a respective communication link with a respective one of multiple STAs 104 of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA 104 is simultaneously transmitted across multiple communication links in parallel to maximize the utilization of available resources to achieve higher throughput. That is, during at least some duration of time, transmissions or portions of transmissions may occur over two or more links in parallel at the same time. In some implementations, the parallel wireless communication links may support synchronized transmissions. In some other examples, or during some other durations of time, transmissions over the links may be parallel, but not be synchronized or concurrent. In some examples or durations of time, two or more of the links may be used for communication between the wireless communication devices in the same direction (such as all uplink or all downlink). In some other examples or durations of time, two or more of the links may be used for communication in different directions. For example, one or more links may support uplink communication and one or more links may support downlink communication. In such examples, at least one of the wireless communication devices operates in a full duplex mode. Generally, full duplex operation enables bi-directional communication where at least one of the wireless communication devices may transmit and receive at the same time.

MLA may be implemented in a number of ways. In some implementations, MLA may be packet-based. For packet-based aggregation, frames of a single traffic flow (such as all traffic associated with a given traffic ID (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally, or alternatively, be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some implementations, the exchange of information may occur via a beacon signal, a probe request or probe response, an association request or an association response frame, a dedicated action frame, or an operating mode indicator (OMI), among other examples. In some implementations, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the quantity of users per multiplexed transmission served by the multi-link AP MLD.

In some systems, a group of Wi-Fi-enabled wearable devices may deliver or otherwise be associated with a same application. Such a group of Wi-Fi-enabled wearable devices delivering a same application may include wireless earbuds, wireless accessories (such as a watch, a bracelet, and/or a ring), health sensors or monitors, wearable wireless media devices, and/or gaming sensors or controllers. For example, two wireless earbuds may deliver audio data for a same music application. As another example, two or more gaming sensors and/or controllers may deliver input data (associated with motion and/or controller inputs) for a same video game application. Because each Wi-Fi device generally has its own unique MAC address, each device of a group of Wi-Fi-enabled wearable devices typically performs an independent connection setup procedure to connect with a WLAN. In other words, each wearable device of a group of Wi-Fi-enabled wearable devices may be seen as a distinct peer device to a handset, a compute device, and/or an AP in the WLAN. A compute device may be equivalently referred to as an edge compute device, a network edge device, or a compute node, and may be an example of an AP 102, a STA 104, a router, a mobile device, a vehicle, a laptop, a gaming console, an IoT device, or any other device connected to the network that may have processing and/or computational capabilities. In some scenarios, an end device (such as a wearable device) may rely on an edge node to process, analyze, and/or execute relatively larger computing workloads (such as processing tasks) that may otherwise result in delays and/or power consumption at the end device.

For example, a first wearable device may exchange a first set of frames with a handset, AP, or compute device as part of a first connection setup and a second wearable device may independently exchange a second set of frames with the handset, AP, or compute device as part of a second connection setup. Such first and second sets of frames may each include one or more frames and/or operations associated with a channel scan, authentication, association, an extensible authentication protocol (EAP), an EAP over LAN (EAPOL), a key exchange, an address resolution protocol (ARP), a dynamic host configuration protocol (DHCP), a BA negotiation, and/or a TWT session setup sequence. As such, the handset, AP, or compute device may independently provision the first wearable device and the second wearable device with Wi-Fi and internet protocol (IP) connections for subsequent data communication.

Such an independent provisioning of Wi-Fi-enabled devices (which may be understood as dual-bud provisioning for a pair of wireless earbuds) may effectively multiply a (re)connection time for a group of wearable devices by a quantity of devices in the group of wearable devices as compared to other communication protocols, which may lead to an unsatisfactory amount of delay (such as latency) at an end user. For example, in the context of two wireless earbuds, an independent provisioning sequence may double the time of an application or session start (and/or double a usage and bandwidth of network resources) and adversely impact a user experience compared to some other communication protocols, such as a Bluetooth protocol.

Some deployments associated with an extended personal area network (XPAN) may have flexibility in terms of enabling Wi-Fi-enabled wearable devices to have or avoid having distinct IP connectivity. For example, XPAN applications may run at a handset (such that a handset is frequently a traffic source device), a same or similar application traffic may be transmitted to each wearable device of a group of wearable devices, and wearable devices of a group of wearable devices may be mostly collocated, and each of such characteristics may support flexibility in terms of whether a given wearable device is expected to have distinct IP connectivity. For example, such characteristics may enable wearable devices of a group of wearable devices to avoid having distinct IP connectivity.

A group of wearable devices may leverage such characteristics and, in some implementations, the group of wearable devices may negotiate (such as coordinate, via signaling exchange(s) amongst each other via one or more secure peer-to-peer wireless communication links) and select a master (or primary) wearable device of the group of wearable devices, and such a master wearable device may perform signaling exchanges in association with provisioning on behalf of the entire group of wearable devices. For example, the group of wearable devices may further establish (such as negotiate, indicate, select, or otherwise determine) a shared address that corresponds to the group of wearable devices and the master wearable device may use the shared address in association with establishing a wireless communication link to an XPAN host. Such an XPAN host may be a traffic source device (for point-to-point deployment scenarios) or another wireless communication device along an end-to-end path between the traffic source device and the master wearable device (such as a nearby AP 102 or a nearby STA 104 functioning as a soft AP for relay deployment scenarios). In accordance with establishing the wireless communication link using the shared address, the group of wearable devices may appear as one device to the XPAN host. Likewise, and in accordance with the example implementations described herein, an XPAN host and/or one or more wearable devices of the group of wearable devices may use the shared address to manage signaling exchanges and/or operations associated with connection (re)setup, data exchange, and connection teardown.

In some implementations, wearable devices of the group of wearable devices may differentiate traffic in accordance with respective link IDs corresponding to each respective wearable device. In other words, for example, communication to or from the wearable devices may be associated with the shared address (such that the shared address may be present in, for example, a receiver address and/or a transmitter address of packets) and wireless communication devices (such as any one or more of an XPAN host or a wearable device) may determine to which wearable device traffic is applicable to in accordance with a link ID associated with the traffic. In some implementations, the wearable devices may negotiate and/or assign unique link IDs to each wearable device and a wearable device may selectively receive packets associated with a link ID corresponding to that wearable device. In some aspects, a link ID may be a TID or other information indicative of a traffic class (such that, in the example of wireless earbuds, traffic to and/or from the wireless earbuds is differentiated over two traffic classes, respectively). In some implementations, the group of wearable devices may operate in accordance with the shared address under some conditions and may fall back to another provisioning mechanism (such as an independent provisioning mechanism) when such conditions are not met.

One or more wireless communication devices (such as an XPAN host and/or one or more wearable devices) may leverage the example implementations described herein to reduce (such as by at least one-half) provisioning overhead involving sequences such as authentication, association, EAP or key exchange, ARP, and/or DHCP lease (providing more DHCP scope for other wireless communication devices in the system), which may reduce streaming start latencies. Further, in examples in which MLO is supported, the one or more wireless communication devices may use a TID-to-link-mapping (T2LM) scheme to multiplex traffic via different frequencies. Additionally, or alternatively, the group of wearable devices may perform localized role switches (such as one wearable device may go off-channel for a scan procedure (for itself or as an extended radio for an XPAN host) while at least one other wearable device continues to transmit and/or receive traffic) without performing an explicit handshake with an XPAN host, which may increase system robustness by enabling more flexible operation (including flexibility to search for another serving device that provides greater link conditions).

Further, various messages are described herein as packets. A packet may include a header portion and/or a data portion. A packet may be an example of a frame, may be included within a frame, or may include a frame. Further, although described in the example of wearable devices, the techniques of the present disclosure may be applicable to any set or group of wireless communication devices (such as any set or group of end devices) that have an association or relation to each other (by, for example, serving a same or similar application). As such, any wireless device may perform the described signaling and/or control operations without exceeding the scope of the present disclosure.

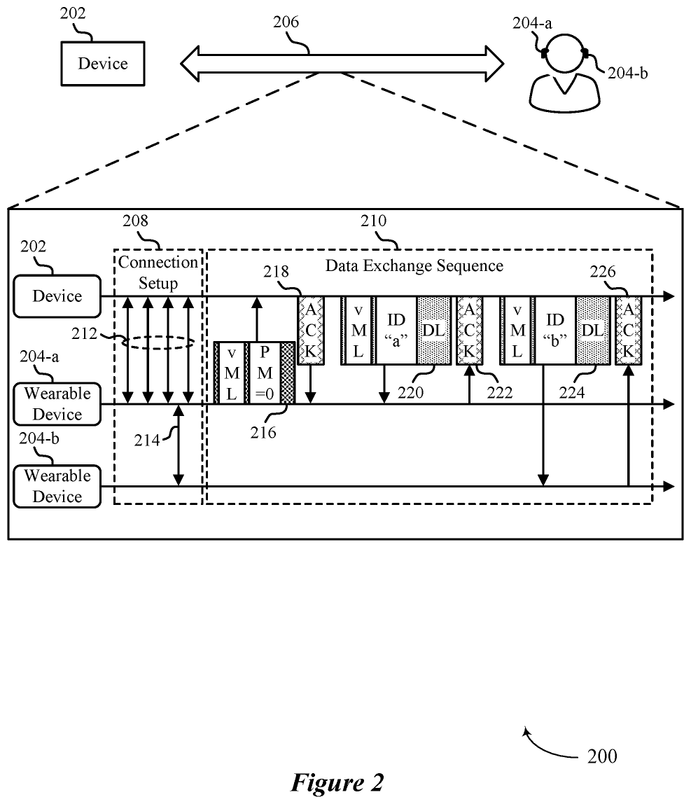

FIG. 2 shows an example signaling diagram 200 that supports managing a group of Wi-Fi-enabled wearable or handheld wireless devices using a shared address according to some aspects of the present disclosure. The signaling diagram 200 may implement or be implemented to realize aspects of the WLAN 100. For example, the signaling diagram 200 illustrates communication between a wireless communication device 202 and a group of wearable devices (including a wearable device 204-a and a wearable device 204-b) via a wireless communication link 206 (such as a Wi-Fi link). The wearable device 204-a and the wearable device 204-b may be understood as being part of a same group of wearable devices in accordance with the wearable device 204-a and the wearable device 204-b serving a same or similar purpose, a same or similar use case, and/or a same or similar application. In other words, although the wearable device 204-a and the wearable device 204-b may be two physically distinct devices, the wearable device 204-a and the wearable device 204-b may serve a same or similar purpose and be understood as related to associated to each other in accordance with serving the same or similar purpose. Further, although described in the example of the signaling diagram 200 as wearable devices, the wearable device 204-a and/or the wearable device 204-b may equivalently be examples of handheld devices (such as a gaming controller).

For example, the wearable device 204-a and the wearable device 204-b may be examples of two wireless earbuds serving a same music application (as illustrated in the example of the signaling diagram 200), two controllers or sensors serving a same video game application, or two health monitors tracking similar metrics and/or performing similar functions. Further, although illustrated in the example of the signaling diagram as including two wearable devices, a group of wearable devices may include any quantity of wearable devices, such as two, three, four, five, and so on. The wireless communication device 202 may be an example of a serving device, such as a traffic source/sink device or an AP 102. A traffic source/sink device may be a phone, mobile device, a tablet, a personal computer, a compute device, or a gaming console, among other examples of a wireless communication device having data generation and/or data processing capabilities.

In some deployments, the wireless communication device 202 and the group of wearable devices may be part of (such as members of or otherwise connected to) an XPAN. In such deployments, the wearable device 204-a and the wearable device 204-b may be Wi-Fi-enabled (such as Wi-Fi equipped) and may support one or more mechanisms to meet expectations of latency, robustness, and power consumption. In accordance with being members of an XPAN, for example, the wearable device 204-a and the wearable device 204-b may support mechanisms to reduce latency and achieve seamless transitions from one serving device to another serving device (such as from AP to AP). For example, the wearable device 204-a and the wearable device 204-b may support mechanisms to keep voice calls at a latency at which users may continue to engage in the voice call while roaming on a Wi-Fi AP infrastructure and meeting specification- and ecosystem-based end-to-end latency targets (such as while maintaining user comfort). Further, the wearable device 204-a and the wearable device 204-b may support mechanisms to allow a user to freely roam around a Wi-Fi extender or mesh network infrastructure with a relatively low likelihood of breaks or drops in service (such as in audio) during, for example, an AP-AP transition.

In some systems, however, an XPAN host (such as a traffic source device, an AP, or a compute device) may serve the wearable device 204-a and the wearable device 204-b as distinct and separate wireless communication devices. In other words, although the wearable device 204-a and the wearable device 204-b may be in a same group of wearable devices serving a same or similar purpose, some Wi-Fi designs may result in the wearable device 204-a and the wearable device 204-b being communicated to as two independent client devices from the network perspective. In accordance with being communicated to as two independent client devices, a serving device and/or the wearable devices may experience increased Wi-Fi (re)connection times (as each of the wearable device 204-a and the wearable device 204-b may be expected to perform separate connection setup procedures, including separate control and management frame exchanges, effectively doubling connection time). For example, in examples in which each of the wearable device 204-a and the wearable device 204-b perform a separate, individual connection setup, the wearable device 204-a and the wearable device 204-b may approximately double network management and control traffic (along with peer management overhead) on the serving device.

In an example in which the wearable device 204-a and the wearable device 204-b are wireless earbuds, for instance, if a user is currently using the wearable device 204-a and subsequently takes the wearable device 204-b out of a case, the wearable device 204-b may be expected to perform a complete Wi-Fi reconnection process. Such a complete Wi-Fi reconnection process may include scanning (active or passive), authentication (which may include an authentication request packet and an authentication response packet), association (which may include an association request packet and an association response packet), security key exchange (such as via an EAPOL, which may include an exchange of four messages M1, M2, M3, and M4), an ARP, and a DHCP (which may include a DHCP discover packet, a DHCP offer packet, a DHCP request packet, and a DHCP ACK packet). The complete Wi-Fi reconnection process may take an amount of time proportional to a network congestion level (such as an amount of devices in the network). For example, the complete Wi-Fi reconnection process may take between approximately 2 seconds and approximately 5 seconds in accordance with the network congestion level, which may be unsatisfactory to an end user as compared to some other wearable device connection mechanisms.

Further, in accordance with being communicated to as two independent client devices and likewise having independent data streams, a serving device and/or the wearable devices also may experience increased delay or jitter for data sent to both the wearable device 204-a and the wearable device 204-b, larger DHCP lease scope granted of each wearable device, and higher power management costs of each wearable device at the serving device (as the serving device may maintain a power management state of all wearable devices individually to avoid transmissions to a wearable device in a sleep state; such transmissions may be referred to as leaky packet delivery). In some aspects, the wearable device 204-a and the wearable device 204-b may experience increased delay or jitter especially for data sent from an AP 102 in a whole home coverage (WHC) use case. For example, in a WHC use case, an AP 102 may lack knowledge that the wearable device 204-a and the wearable device 204-b are related (such as belong to a same group of wearable devices) and may communicate with the wearable device 204-a and the wearable device 204-b as two independent connected devices, which may cause interruptions or discontinuity between service of the wearable device 204-a and service of the wearable device 204-b.

In other words, because APs 102 may serve many connected Wi-Fi devices, an AP 102 may serve (such as relay data from a traffic source device to) the wearable device 204-a, serve one or more other client devices, and then serve (such as relay data from the traffic source device to) the wearable device 204-b, which may result in a time gap between service of the wearable device 204-a and service of the wearable device 204-b. To address such a possibility for increased delay or jitter in WHC use cases (and because both wearable devices may render data at the same time or otherwise in synchronization), the wearable device 204-a and the wearable device 204-b may use larger buffers to avoid a rendering delay between the wearable device 204-a and the wearable device 204-b, which may translate or otherwise result in higher end-to-end latency, larger memory storage space, larger device size, and cost at the wearable device 204-a and the wearable device 204-b. Due to a small form factor and/or low target cost of some wearable devices (such as health monitors and wireless earbuds), such large memory or buffers may compromise usability, user experience, and/or adoption.

In some implementations, to mitigate or otherwise remedy such latency and/or costs, the wireless communication device 202 and the group of wearable devices may support one or more mechanisms associated with using a shared address as part of a connection setup procedure 208 and a data exchange sequence 210. In other words, the wireless communication device 202 may manage the wearable device 204-a and the wearable device 204-b in accordance with a shared address corresponding to an association of (such as a grouping of) the wearable device 204-a and the wearable device 204-b, and such management may include signaling exchanges associated with the connection setup procedure 208 (which also may be a reconnection setup procedure), the data exchange sequence 210, and any connection teardown procedure. Such a shared address may alternatively be referred to or understood as a virtual multi-link (vML) address and the connection setup procedure 208 using such a vML address may be understood as vML-based provisioning as, for example, using a same shared address and differentiating traffic by other indications or mechanisms may be understood as using multiple “virtual links” with respect to the “one link” that is established using the shared address. Likewise, a shared address and a vML address may be used interchangeably herein, including in the drawings, and, in some aspects, the group of wearable devices together may be understood as a vML device (with two or more physically separated devices). In some aspects, each different group of wearable devices may have a unique shared address corresponding to that group of wearable devices.

In some implementations, the wearable device 204-a and the wearable device 204-b may communicate a first set of packets indicating the shared address. For example, the wearable device 204-a and the wearable device 204-b may transmit and/or receive the first set of packets as part of a negotiation or sharing of the shared address between the wearable device 204-a and the wearable device 204-b. In some implementations, the shared address may be (such as in accordance with device configurations) a MAC address of the wearable device that performs the connection setup procedure 208 on behalf of the group of wearable devices. In some implementations, the wearable device 204-a and the wearable device 204-b may negotiate which of the wearable device 204-a or the wearable device 204-b is to perform the connection setup procedure 208 using the shared address, and the wearable device that performs the connection setup procedure 208 may be understood as functioning in a master role. In some aspects, the wearable device 204-a and the wearable device 204-b also may negotiate and assign a respective link ID (such as a TID or other information indicative of a traffic class) to each of the wearable device 204-a and the wearable device 204-b via the first set of packets, which the wearable device 204-a and the wearable device 204-b may use to differentiate between data traffic intended for the wearable device 204-a and data traffic intended for the wearable device 204-b. In some implementations, the first set of packets may indicate a first link ID “a” corresponding to the wearable device 204-a and a second link ID “b” corresponding to the wearable device 204-b.

In some implementations, the link ID “a” may correspond to a first TID (such as a TID6) and the link ID “b” may correspond to a second TID (such as a TID7). In some aspects, the first TID and the second TID may be of a same access category. In some other aspects, the first TID and the second TID may be of different access categories. Although described in this example as there being a “correspondence” between a link ID and a TID, there may not necessarily be a one-to-one relationship between link ID and TID. For example, multiple TIDs may map to a single link ID and/or a single TID may map to multiple link IDs.

In some implementations, the wearable device 204-a and the wearable device 204-b may exchange the first set of packets via a first wireless communication link between the wearable device 204-a and the wearable device 204-b, which may be an example of any secure peer-to-peer link. For example, such a first wireless communication link may be a Bluetooth link, a Wi-Fi link, or an ultra-wideband (UWB) link, among any other example of a peer-to-peer link. In some implementations, the wearable device 204-a and the wearable device 204-b may secure the first wireless communication link to provide a safe haven for an exchange of sensitive Wi-Fi link-specific information between the wearable device 204-a and the wearable device 204-b. For example, the wearable device 204-a and the wearable device 204-b may communicate using a specific encryption (such as advanced encryption standard (AES)-128) with a message integrity check (MIC) (such as a 4-byte MIC).

As part of the connection setup procedure 208, in examples in which the wearable device 204-a takes the role of master, the wearable device 204-a may communicate a set of packets 212 with (such as transmit to and/or receive from) the wireless communication device 202. For example, the wearable device 204-a may transmit a second set of packets to the wireless communication device 202 and may receive packets responsive to the second set of packets to establish the wireless communication link 206 (which may sometimes be referred to herein as a second wireless communication link) with the wireless communication device 202. The set of packets 212 may include one or more packets associated with authentication, one or more packets associated with association, one or more packets associated with an EAPOL, one or more packets associated with a security key exchange, one or more packets associated with a DHCP, and one or more packets associated with adding a BA session. At least one of the set of packets 212 may indicate the shared address, the first link ID “a” corresponding to the wearable device 204-a, and the second link ID “b” corresponding to the wearable device 204-b.

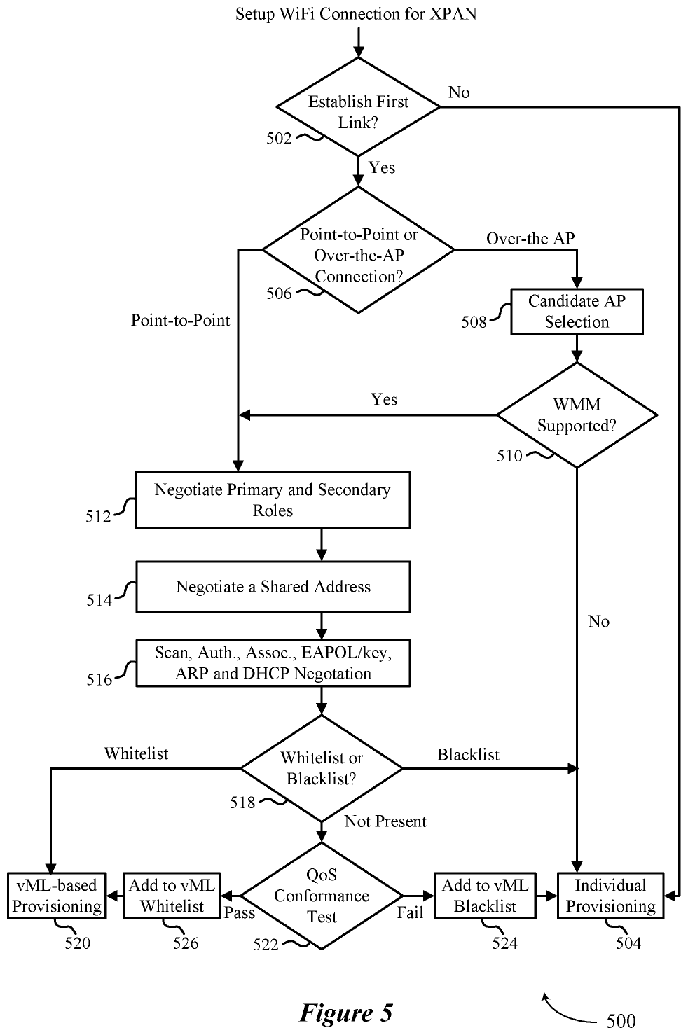

In some implementations, the wearable device 204-a may communicate one or more packets 214 with the wearable device 204-b during (and/or prior to) the connection setup procedure 208 to coordinate with the wearable device 204-b on how the wireless communication link 206 is set up. Additional details relating to such communication between the wearable device 204-a and the wearable device 204-b are illustrated by and described with reference to FIG. 5. In accordance with use of the shared address for the connection setup procedure 208, the wearable device 204-a and the wearable device 204-b may leverage single peer control and management message exchanges and appear as one connected device (such as one connected peer), which may reduce (such as halve) connection setup times and network control and/or management overhead.

In accordance with establishing the wireless communication link 206, the wearable device 204-a (functioning in the master role) may transmit a packet 216 to the wireless communication device 202 indicating the shared address (such as the vML address) and indicating a power management state corresponding to the shared address. In some implementations, the wearable device 204-a may coordinate with the wearable device 204-b on the power management state such that the power management state indicated via the packet 216 is indicative of (such as representative of) both a power management state of the wearable device 204-a and the wearable device 204-b. In other words, the wearable device 204-a and the wearable device 204-b may synchronize power management states such that both are in an awake state at a same time. The wireless communication device 202 may transmit an ACK 218 to the wearable device 204-a in accordance with receiving the packet 216, which may confirm to the wearable device 204-a that the wireless communication device 202 successfully received the indication of the power management state corresponding to the shared address. In some aspects, the packet 216 may be a null data packet, such as a QoS NULL packet.

In examples in which the power management state corresponding to the shared address indicates that both the wearable device 204-a and the wearable device 204-b are in an awake state (such as in examples in which a power management bit in the packet 216 is set to 0), the wireless communication device 202 may begin a data transmission to the wearable device 204-a and the wearable device 204-b. For example, the wireless communication device 202 may transmit a packet 220 and a packet 224, each including downlink (which may be referred to as DL) data. In some implementations, the wireless communication device 202 may transmit an indication of the shared address and a link ID in each of the packet 220 and the packet 224. For example, the packet 220 may include an indication of the shared address and the link ID “a” corresponding to the wearable device 204-a and the packet 224 may include an indication of the shared address and the link ID “b” corresponding to the wearable device 204-b. In other words, the wireless communication device 202 may send data to both the wearable device 204-a and the wearable device 204-b independently over separate link IDs (such as separate TIDs or traffic classes). In some aspects, the wireless communication device 202 (such as a traffic source device) may embed an IP type of service (TOS) value mapped to either link ID in the packets (such as in audio data packets, and a same traffic priority and classification may be applied for raw audio ethernet packets, which may be used for direct communication between a traffic source device and the wearable devices). In some implementations, the IP TOS value may enable traffic class or priority information to be carried forward and retained across multiple hops between a traffic source device and the wearable devices.

As such, the wearable device 204-a may receive and attempt to decode the packet 220 in accordance with the packet 220 including the indication of the link ID “a” and, if successful, the wearable device 204-a may transmit an ACK 222 to the wireless communication device 202 associated with the packet 220. Similarly, the wearable device 204-b may receive and attempt to decode the packet 224 in accordance with the packet 224 including the indication of the link ID “b” and, if successful, the wearable device 204-b may transmit an ACK 226 to the wireless communication device 202 associated with the packet 224. In some implementations, the wearable device 204-a may refrain from attempting to (fully) decode the packet 224 in accordance with the packet 224 including the indication of the link ID “b” and the wearable device 204-b may refrain from attempting to (fully) decode the packet 220 in accordance with the packet 220 including the indication of the link ID “a.” In some aspects, the packet 220 may be part of a first data stream for the wearable device 204-a and the packet 224 may be part of a second data stream for the wearable device 204-b and the two data streams for the wearable device 204-a and the wearable device 204-b may be differentiated over link IDs. In some aspects, the wireless communication device 202 may transmit the packet 220 and the packet 224 via a same frequency channel. In some other aspects (such as in examples in which the wireless communication device 202 is an MLD), the wireless communication device 202 may transmit the packet 220 and the packet 224 via different frequency channels.

In some implementations, the packet 220 and the packet 224 may include different information, each including information specific to one of the wearable device 204-a and the wearable device 204-b. In such implementations, a traffic source device (such as the wireless communication device 202) may generate the information included in the packet 220 and the packet 224 in accordance with to which wearable device each of the packet 220 and the packet 224 are intended. For example, the packet 220 may include first information specific to the wearable device 204-a and the packet 224 may include second information specific to the wearable device 204-b. In some other implementations, the packet 220 and the packet 224 may include some at least partially overlapping information. For example, the wireless communication device 202 may apply some amount of duplication of data and include both the first information and the second information in each of the packet 220 and the packet 224, which may enable some post-processing operations at the wearable devices (such as to facilitate a perception of 3-dimensional audio for an end user).

The wearable device 204-a and the wearable device 204-b may periodically exchange information associated with a (desired) power management state and, in examples in which at least one of the wearable device 204-a and the wearable device 204-b indicates an expectation to enter a sleep state, the wearable device 204-a (the master) may transmit a packet (such as another null data packet) indicating the shared address and an updated power management state corresponding to the shared address. In examples in which at least one of the wearable device 204-a and the wearable device 204-b indicates an expectation to enter a sleep state, the wearable device 204-a may set a power management bit to 1. As such, the group of wearable devices including at least the wearable device 204-a and the wearable device 204-b may manage and organize communication with the wireless communication device 202 using the shared address and differentiating traffic using differing link IDs. For example, if a wearable device becomes disconnected and attempts to reconnect, the reconnecting wearable device may avoid any additional reconnection signaling overhead (as another link between the group of wearable devices and the wireless communication device 202 will likely still be operation and can be used to re-establish the “link” that went down). Additionally, in accordance with using the shared address to manage and organize communication, periodic groupwise rekey exchanges may be reduced by, for example, approximately one-half for the wearable device 204-a and the wearable device 204-b.

Further, although described in the example of downlink data transmission with reference to the signaling diagram 200, the described techniques may be equivalently applicable to uplink data transmission. For example, the wearable device 204-a may transmit a first set of one or more packets including an indication of the shared address and the link ID “a” and the wearable device 204-b may transmit a second set one or more packets including an indication of the shared address and the link ID “b.” As such, the wireless communication device 202 may receive the packets as if the packets were sent by a single wireless communication device, but a traffic sink device (such as a device ultimately responsible for parsing the packets and using data received via the packets for one or more operations) may decode the packets and expect (such as identify or otherwise understand) that data obtained via the first set of packets originated at the wearable device 204-a and that data obtained via the second set of packets originated at the wearable device 204-b. Further, although illustrated in the example of the signaling diagram 200 as a single hop between the wireless communication device 202 and the group of wearable devices, the described techniques may be applicable to relay or mesh deployments in which data may be relayed to or from the group of wearable devices and a traffic source/sink device over any quantity of hops.

As such, in accordance with the example implementations of the present disclosure, link identity information (such as information indicative of a link ID) may be retained and carried over both point-to-point and over AP(s) 102 (in a mesh or enterprise network). A content of some fields, however, may not be carried over multiple hops (as, for example, content of signal (SIG) fields and 802.11 headers, including a QoS control field and an HT control field, may not be carried over multiple hops in some systems), although an understanding of link identify information (such as a semantics of link identify information) may apply to both Layer 2 (L2) and Layer 3 (L3). For example, a traffic class or service may map to a TID in some headers (such as an 802.11 header) and to a type of service (TOS) in some other headers (such as in an IP header). In some implementations, traffic class fields present in L2 and L3 headers may be mapped to each other and retained across potentially multiple hops between traffic endpoints.

Further, the described techniques may be implemented to account for power management of multiple wearable devices individually while the wearable devices are associated through a shared address, such as via a TWT session setup in accordance with link ID. Further, in some implementations, the wearable device 204-a and the wearable device 204-b may support a fallback mechanism to individual provisioning in examples in which shared address-based provisioning fails to satisfy one or more conditions. Such a fallback mechanism may be especially useful for over-the-AP topologies and, in some implementations, one or both of the wearable device 204-a and the wearable device 204-b may perform an end-to-end QoS conformance test as part of the fallback mechanism (such as to measure, determine, or otherwise identify whether to initiate a fallback to individual provisioning). Further, the described messaging formats and exchanges may be applicable to various types of deployment scenarios and to various types of devices. For example, the described messaging formats and exchanges may be supported by devices and networks of various manufacturers.

Further, in implementations in which the wireless communication device 202 is capable of multi-link operation (MLO), the wireless communication device 202 may use a T2LM scheme or other link mapping scheme to map each TID or link ID (such as each wearable device) to a specific link of the wireless communication device 202. For example, in examples in which the wireless communication device 202 is an MLD able to operate multiple links (such as a 2.4 GHz link, a 5 GHz link, and/or a 5 GHz link), the wireless communication device 202 may support simultaneous transmission to and/or reception from the wearable device 204-a and the wearable device 204-b on two different links, the two different link corresponding to two different radio frequency channels. In such implementations, the wireless communication device 202 may transmit an indication of the T2LM and the wearable device 204-a may tune at least one radio to a first frequency channel to which the link ID “a” is mapped and the wearable device 204-b may tune at least one radio to a second frequency channel to which the link ID “b” is mapped. As such, the wireless communication device 202 may support greater MAC efficiency, enable more concurrency time on the wireless communication device 202, reduce power consumption on each of the wearable device 204-a and the wearable device 204-b, and reduce delay and/or jitter between data to the wearable devices, which may in turn reduce memory constraints, size, and cost of the wearable devices.

In accordance with using a shared address for a connection setup procedure, aspects of the present disclosure may be implemented to realize various addressing formats for various link types. For ethernet addressing, for example, an example addressing of packets may be [H_{SAP}-M-vML-M] and [vML-M-H_{SAP}-M]. For 802.11 addressing for point-to-point communication, an example addressing of packets may be [vML-M-H_{SAP}-M-H_{SAP}-M] and [H_{SAP}-M-vML-M-H_{SAP}-M]. For 802.11 addressing for over-the-AP communication, an example addressing of packets may be [AP_{X}-M-H_{STA}-M-vML-M], [vML-M-AP_{X}-M-H_{STA}-M], [AP_{X}-M-vML-M-H_{STA}-M], and [H_{STA}-M-AP_{X}-M-vML-M]. In such examples, H_{SAP}-M may be an address of a traffic source/sink device for ethernet or direct wireless communication, vML-M may be an address of the group of wearable devices, H_{STA}-M may be an address of a traffic source/sink device for relayed wireless communication, and AP_{X}-M may be an address of an AP 102 via which packets are relayed between a traffic source/sink device and the group of wearable devices.

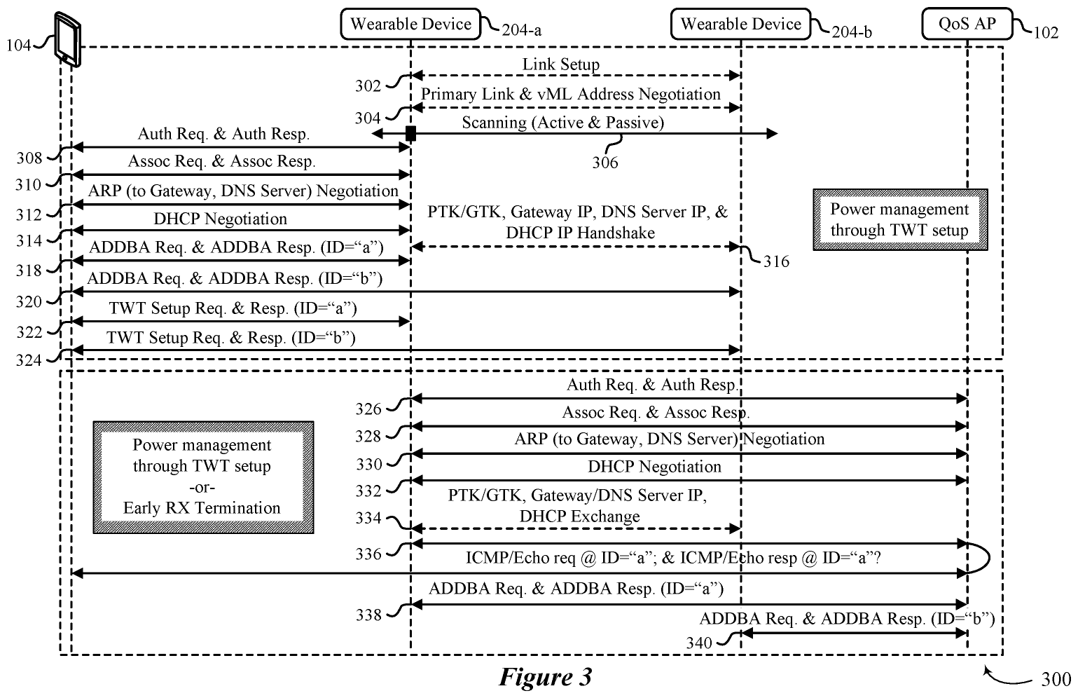

FIG. 3 shows an example process flow 300 that supports managing a group of Wi-Fi-enabled wearable or handheld wireless devices using a shared address according to some aspects of the present disclosure. The process flow 300 may implement or be implemented to realize or facilitate aspects of the WLAN 100 and the signaling diagram 200. For example, the process flow 300 illustrates communication between a STA 104 (which may be an example of a traffic source/sink device), the wearable device 204-a, the wearable device 204-b, and an AP 102 (which may be an example of a QoS AP 102). The wireless communication device 202 illustrated by and described with reference to FIG. 2 may be an example of the STA 104 or the AP 102. In some implementations, the wearable device 204-a and the wearable device 204-b may be associated with a same group of wearable devices and may use a shared address to perform a connection setup procedure with the STA 104 (for point-to-point communication) or the AP 102 (for over-the-AP relay communication), such as a connection setup procedure 208 as illustrated by and described with reference to FIG. 2.

In the following description of the process flow 300, the operations may be performed (such as reported or provided) in a different order than the order shown, or the operations performed by the example devices may be performed in different orders or at different times. For example, specific operations also may be left out of the process flow 300, or other operations may be added to the process flow 300. Further, although some operations or signaling may be shown to occur at different times for discussion purposes, these operations may actually occur at the same time.

At 302, the wearable device 204-a and the wearable device 204-b may communicate (such as transmit and/or receive) one or more packets in accordance with establishing (such as setting up) a first wireless communication link. The first wireless communication link may be a secure peer-to-peer link, such as a Bluetooth link, a Wi-Fi link, or a UWB link.

At 304, the wearable device 204-a and the wearable device 204-b may communicate (such as transmit and/or receive) one or more packets in accordance with a negotiation of a primary link and/or a negotiation of a shared address (such as a vML address). For example, the wearable device 204-a and the wearable device 204-b may exchange one or more packets indicating which of the wearable device 204-a and the wearable device 204-b is to take a master role and perform a connection setup procedure and/or may exchange one or more packets indicating a shared address that is to be used for the connection setup procedure. In some aspects, the same set of frames or different sets of frames may indicate which wearable device is to take the master role and the shared address. The primary link may be understood as the link or device via which the connection setup procedure is to be performed on behalf of other link(s) or device(s) of the group of wearable devices. Additionally, in some implementations, the wearable device 204-a and the wearable device 204-b may communicate one or more packets indicating, with respect to the shared address, a link ID “a” corresponding to the wearable device 204-a and a link ID “b” corresponding to the wearable device 204-b. For example, the wearable device 204-a and the wearable device 204-b may transmit and/or receive packets in accordance with a negotiation (such as coordination) of link ID assignments. As such, the wearable device 204-a and the wearable device 204-b may use the same shared address (such as a same transmitter address or receiver address) and instead differentiate traffic in accordance with respective (and unique) link IDs.

At 306, in examples in which the wearable device 204-a is indicated or otherwise selected to take the primary role and perform the connection setup procedure, the wearable device 204-a may perform a scanning operation. Such a scanning operation may include one or both of passive scanning and active scanning and the wearable device 204-a may perform the scanning operation to discover a wireless communication device with which to connect to obtain internet or network access. In some implementations, the wearable device 204-a may discover the STA 104 (such as the traffic source/sink device). In some other examples, the wearable device 204-a may discover the AP 102 (such as a wireless communication device along a relay path between the traffic source/sink device and the wearable device 204-a.

At 308, in examples in which the wearable device 204-a discovers the STA 104 in accordance with the scanning operation, the wearable device 204-a and the STA 104 may exchange one or more authentication packets. For example, the wearable device 204-a may transmit an authentication request to the STA 104 and the STA 104 may transmit an authentication response corresponding to the authentication request. In some implementations, the wearable device 204-a and the STA 104 may include an indication of the shared address in both of the authentication request and the authentication response in accordance with the shared address-based provisioning.

At 310, the wearable device 204-a and the STA 104 may communicate one or more association packets. For example, the wearable device 204-a may transmit an association request to the STA 104 and the STA 104 may transmit an association response corresponding to the association request. In some implementations, the wearable device 204-a and the STA 104 may include an indication of the shared address in both of the association request and the association response in accordance with the shared address-based provisioning.

At 312, the wearable device 204-a and the STA 104 may communicate one or more packets associated with an ARP negotiation. In accordance with the ARP negotiation, the wearable device 204-a may receive an indication of a gateway and a domain name system (DNS) server associated with communication with the STA 104. In some implementations, the wearable device 204-a and the STA 104 may include an indication of the shared address in the one or more packets associated with the ARP negotiation in accordance with the shared address-based provisioning.

At 314, the wearable device 204-a and the STA 104 may communicate one or more packets associated with a DHCP negotiation. In some aspects, the one or more packets associated with the DHCP negotiation may indicate, to the wearable device 204-a, an IP address. In some implementations, the IP address may correspond to the group of wearable devices in accordance with the shared address-based provisioning. In accordance with the packet exchanges at 308, 310, 312, and 314, the wearable device 204-a may establish a second wireless communication link with the STA 104. In some implementations, the wearable device 204-a may establish the second wireless communication link for both the wearable device 204-a and the wearable device 204-b in accordance with using the shared address. Additionally, in some implementations, the wearable device 204-a may provide an indication of the link ID “a” (corresponding to the wearable device 204-a) and the link ID “b” (corresponding to the wearable device 204-b) via any one or more of the packet exchanges at 308, 310, 312, and 314. In implementations in which the STA 104 is a traffic source device, the STA 104 may use the indication of the link ID “a” to generate and deliver first data packets specific to the wearable device 204-a and may use the link ID “b” to generate and deliver second data packets specific to the wearable device 204-b.

At 316, the wearable device 204-a and the wearable device 204-b may communicate one or more packets in accordance with the wearable device 204-a establishing the second wireless communication link with the STA 104. In some aspects, such one or more packets may indicate, to the wearable device 204-b, information indicative of a pairwise transient key (PTK), a group temporary key (GTK), a gateway IP, a DNS server IP, and a DHCP IP handshake. In some implementations, the wearable device 204-a and the wearable device 204-b may negotiate (such as coordinate) on such security keys and/or IP addresses and the wearable device 204-a may establish the second wireless communication link in accordance with the negotiation. In some aspects, such negotiation may be associated with respective capabilities of the wearable device 204-a and the wearable device 204-b.

At 318, in accordance with establishing the second wireless communication link, the wearable device 204-a may communicate one or more packets with the STA 104 to establish a first BA session between the wearable device 204-a and the STA 104. For example, one of the wearable device 204-a and the STA 104 may transmit an ADDBA request to the other of the wearable device 204-a and the STA 104, and the other of the wearable device 204-a and the STA 104 may transmit an ADDBA response corresponding to the ADDBA request. In some implementations, the wearable device 204-a and the STA 104 may include the link ID “a” (along with the shared address) in the ADDBA request and ADDBA response to establish the first BA session specifically for the wearable device 204-a.

At 320, in accordance with the wearable device 204-a establishing the second wireless communication link with the STA 104, the wearable device 204-b may communicate one or more packets with the STA 104 to establish a second BA session between the wearable device 204-b and the STA 104. For example, one (such as a data transmitter) of the wearable device 204-b and the STA 104 may transmit an ADDBA request to the other of the wearable device 204-b and the STA 104, and the other of the wearable device 204-b and the STA 104 may transmit an ADDBA response corresponding to the ADDBA request. In some implementations, the wearable device 204-b and the STA 104 may include the link ID “b” (along with the shared address) in the ADDBA request and ADDBA response to establish the second BA session specifically for the wearable device 204-b. In other words, in accordance with the wearable device 204-a establishing the second wireless communication link, the wearable device 204-a and the wearable device 204-b may each establish separate BA sessions for data transmission, and each of the wearable device 204-a and the wearable device 204-b may individually acknowledge received data.

At 322, in some implementations, the wearable device 204-a and the STA 104 may communicate one or more packets associated with a TWT session setup. In other words, the STA 104 may transmit, to the wearable device 204-a, information indicative of a first schedule of communication time intervals during which the wearable device 204-a and the STA 104 may communicate packets associated with the link ID “a.” For example, one (such as a data transmitter) of the wearable device 204-a and the STA 104 may transmit a TWT setup request to the other of the wearable device 204-a and the STA 104, and the other of the wearable device 204-a and the STA 104 may transmit TWT setup response corresponding to the TWT setup request, each of the TWT setup request and the TWT setup response including an indication of the shared address and the link ID “a.” In some implementations, the wearable device 204-a and the STA 104 may establish a TWT schedule for communication associated with the link ID “a” in examples in which both wireless communication devices support TWT operation. Additionally, or alternatively, the wearable device 204-a and the STA 104 may communicate in accordance with a unscheduled automatic power save delivery (U-APSD) mechanism.

At 324, in some implementations, the wearable device 204-b and the STA 104 may communicate one or more packets associated with a TWT session setup. In other words, the STA 104 may transmit, to the wearable device 204-b, information indicative of a second schedule of communication time intervals during which the wearable device 204-b and the STA 104 may communicate packets associated with the link ID “b.” For example, one (such as a data transmitter) of the wearable device 204-b and the STA 104 may transmit a TWT setup request to the other of the wearable device 204-b and the STA 104, and the other of the wearable device 204-b and the STA 104 may transmit TWT setup response corresponding to the TWT setup request, each of the TWT setup request and the TWT setup response including an indication of the shared address and the link ID “b.” In some implementations, the wearable device 204-b and the STA 104 may establish a TWT schedule for communication associated with the link ID “b” in examples in which both wireless communication devices support TWT operation. As such, the STA 104 may establish separate TWT sessions for each link ID (such as for each TID or traffic class and, in turn, for each wearable device of a group of wearable devices). Additionally, or alternatively, the wearable device 204-b and the STA 104 may communicate in accordance with a U-APSD mechanism.

At 326, in alternative examples in which the wearable device 204-a discovers the AP 102 in accordance with the scanning operation, the wearable device 204-a and the AP 102 may exchange one or more authentication packets. For example, the wearable device 204-a may transmit an authentication request to the AP 102 and the AP 102 may transmit an authentication response corresponding to the authentication request. In some implementations, the wearable device 204-a and the AP 102 may include an indication of the shared address in both of the authentication request and the authentication response in accordance with the shared address-based provisioning.

At 328, the wearable device 204-a and the AP 102 may communicate one or more association packets. For example, the wearable device 204-a may transmit an association request to the AP 102 and the AP 102 may transmit an association response corresponding to the association request. In some implementations, the wearable device 204-a and the AP 102 may include an indication of the shared address in both of the association request and the association response in accordance with the shared address-based provisioning.

At 330, the wearable device 204-a and the AP 102 may communicate one or more packets associated with an ARP negotiation. In accordance with the ARP negotiation, the wearable device 204-a may receive an indication of a gateway and a domain name system (DNS) server associated with communication with the AP 102. In some implementations, the wearable device 204-a and the AP 102 may include an indication of the shared address in the one or more packets associated with the ARP negotiation in accordance with the shared address-based provisioning.

At 332, the wearable device 204-a and the AP 102 may communicate one or more packets associated with a DHCP negotiation. In some aspects, the one or more packets associated with the DHCP negotiation may indicate, to the wearable device 204-a, an IP address. In some implementations, the IP address may correspond to the group of wearable devices in accordance with the shared address-based provisioning. In accordance with the packet exchanges at 326, 328, 330, and 332, the wearable device 204-a may establish a second wireless communication link with the AP 102 (as part of a relay path between the STA 104 and the group of wearable devices). In some implementations, the wearable device 204-a may establish the second wireless communication link for both the wearable device 204-a and the wearable device 204-b in accordance with using the shared address. Additionally, in some implementations, the wearable device 204-a may provide an indication of the link ID “a” (corresponding to the wearable device 204-a) and the link ID “b” (corresponding to the wearable device 204-b) via any one or more of the packet exchanges at 326, 328, 330, and 332. The AP 102 may relay such information to the STA 104 and the STA 104 may use the indication of the link ID “a” to generate and deliver (via the AP 102) first data packets specific to the wearable device 204-a and may use the link ID “b” to generate and deliver (via the AP 102) second data packets specific to the wearable device 204-b.

At 334, the wearable device 204-a and the wearable device 204-b may communicate one or more packets in accordance with the wearable device 204-a establishing the second wireless communication link with the AP 102. In some aspects, such one or more packets may indicate, to the wearable device 204-b, information indicative of a PTK, a GTK, a gateway IP, a DNS server IP, and a DHCP IP handshake. In some implementations, the wearable device 204-a and the wearable device 204-b may negotiate (such as coordinate) on such security keys and/or IP addresses and the wearable device 204-a may establish the second wireless communication link in accordance with the negotiation. In some aspects, such negotiation may be associated with respective capabilities of the wearable device 204-a and the wearable device 204-b.

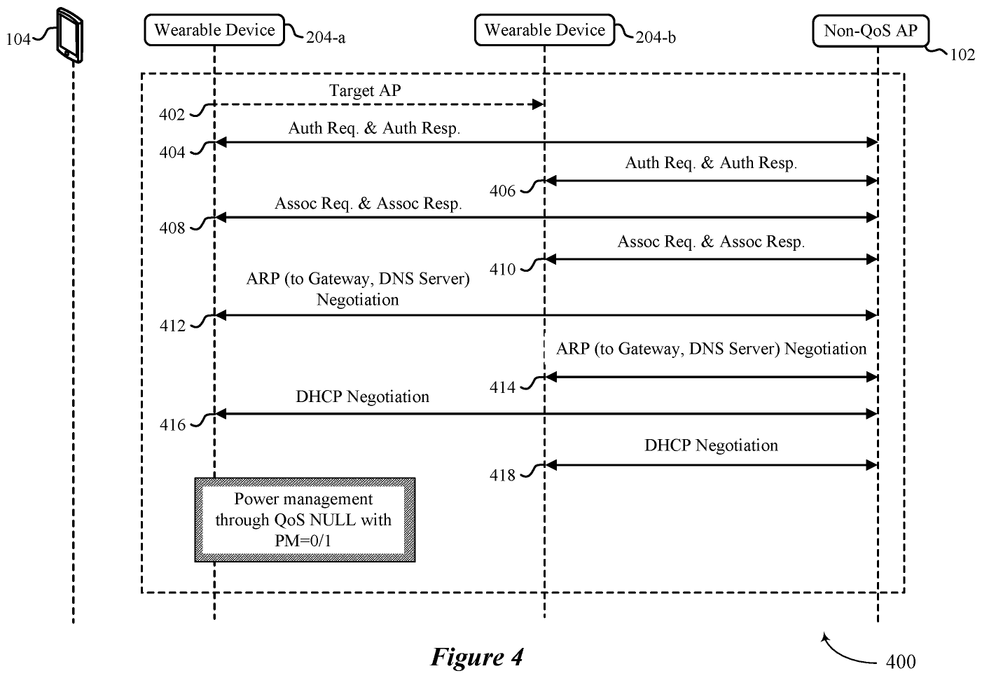

At 336, the wearable device 204-a may perform a QoS conformance test with the AP 102, which may be indicative of whether a relay path between the STA 104 and the wearable device 204-a via the AP 102 is able to support QoS-based traffic prioritization. In accordance with the QoS conformance test, the wearable device 204-a and the STA 104 may exchange, via the AP 102, one or more packets to test whether QoS-based traffic prioritization is maintained (such as preserved) across each hop of the multi-hop relay path. For example, the wearable device 204-a and the STA 104 may exchange, via the AP 102, one or more internet control message protocol (ICMP) packets, such as ICMP Echo request and/or response packets, to test the QoS conformance of the end-to-end relay path between the STA 104 and the wearable device 204-a. In examples in which a responsive ICMP packet, such as an ICMP Echo response, is received at the same priority at which a corresponding request was sent, the end-to-end relay path may successfully pass the QoS conformance test. Otherwise, the end-to-end relay path may fail the QoS conformance test. Additional details relating how the wearable device 204-a may track information associated with which APs 102 pass the QoS conformance test and which APs 102 result in a failure of the QoS conformance test are illustrated by and described in more detail with reference to FIGS. 4 and 5.

At 338, in examples in which the end-to-end relay path passes the QoS conformance test, the wearable device 204-a may proceed with shared address-based provisioning and communicate one or more packets with the AP 102 to establish a first BA session between the wearable device 204-a and the AP 102. For example, one of the wearable device 204-a and the AP 102 may transmit an ADDBA request to the other of the wearable device 204-a and the AP 102, and the other of the wearable device 204-a and the AP 102 may transmit an ADDBA response corresponding to the ADDBA request. In some implementations, the wearable device 204-a and the AP 102 may include the link ID “a” (along with the shared address) in the ADDBA request and ADDBA response to establish the first BA session specifically for the wearable device 204-a. As part of the first BA session, the wearable device 204-a may employ TWT-based transmission and/or reception or may employ early receive termination to manage power consumption at the wearable device 204-a (depending on a capability of, for example the AP 102).

At 340, the wearable device 204-b may likewise proceed with shared address-based provisioning and communicate one or more packets with the AP 102 to establish a second BA session between the wearable device 204-b and the AP 102. For example, one of the wearable device 204-b and the AP 102 may transmit an ADDBA request to the other of the wearable device 204-b and the AP 102, and the other of the wearable device 204-b and the AP 102 may transmit an ADDBA response corresponding to the ADDBA request. In some implementations, the wearable device 204-b and the AP 102 may include the link ID “b” (along with the shared address) in the ADDBA request and ADDBA response to establish the second BA session specifically for the wearable device 204-b. As part of the second BA session, the wearable device 204-b may employ TWT-based transmission and/or reception or may employ early receive termination to manage power consumption at the wearable device 204-b (depending on a capability of, for example the AP 102).

FIG. 4 shows an example process flow 400 that supports managing a group of Wi-Fi-enabled wearable or handheld wireless devices using a shared address according to some aspects of the present disclosure. The process flow 400 may implement or be implemented to realize or facilitate aspects of the WLAN 100, the signaling diagram 200, or the process flow 300. For example, the process flow 400 illustrates communication between a STA 104 (which may be an example of a traffic source/sink device), the wearable device 204-a, the wearable device 204-b, an AP 102 (which may be an example of a non-QoS AP). The wireless communication device 202 illustrated by and described with reference to FIG. 2 may be an example of the STA 104 or the AP 102. In some implementations, the wearable device 204-a and the wearable device 204-b may be associated with a same group of wearable devices and may fall back from using a shared address to using individual addresses to perform a connection setup procedure with the AP 102 (for over-the-AP relay communication) in examples in which the AP 102 is a non-QoS AP. For example, the process flow 400 illustrates communication between the wearable device 204-a, the wearable device 204-b, and the AP 102 in examples in which the AP 102 fails a QoS conformance test.

In the following description of the process flow 400, the operations may be performed (such as reported or provided) in a different order than the order shown, or the operations performed by the example devices may be performed in different orders or at different times. For example, specific operations also may be left out of the process flow 400, or other operations may be added to the process flow 400. Further, although some operations or signaling may be shown to occur at different times for discussion purposes, these operations may actually occur at the same time.

At 402, the wearable device 204-a may transmit an indication of the target AP 102 to the wearable device 204-b. In some implementations, the wearable device 204-a may transmit the indication of the target AP 102 to the wearable device 204-b in accordance with measuring, receiving an indication, or otherwise determining that the AP 102 is a non-QoS AP (which the wearable device 204-a may determine at 336 with reference to FIG. 3). In accordance with communicating the indication of the target AP 102, the wearable device 204-a and the wearable device 204-b may proceed in accordance with an individual provisioning mechanism according to which each of the wearable device 204-a and the wearable device 204-b perform separate connection setup procedures with the AP 102.

At 404, for example, the wearable device 204-a and the AP 102 may exchange one or more authentication packets. For example, the wearable device 204-a may transmit an authentication request to the AP 102 and the AP 102 may transmit an authentication response corresponding to the authentication request. In some implementations, the wearable device 204-a and the AP 102 may include an indication of a first device-specific address (such as a MAC address specific to the wearable device 204-a) in both of the authentication request and the authentication response in accordance with the individual provisioning, the first device-specific address being specific to the wearable device 204-a.

At 406, the wearable device 204-b and the AP 102 may communicate one or more authentication packets. For example, the wearable device 204-b may transmit an authentication request to the AP 102 and the AP 102 may transmit an authentication response corresponding to the authentication request. In some implementations, the wearable device 204-b and the AP 102 may include an indication of a second device-specific address (such as a MAC address specific to the wearable device 204-b) in both of the authentication request and the authentication response in accordance with the individual provisioning, the second device-specific address being specific to the wearable device 204-b.

At 408, the wearable device 204-a and the AP 102 may communicate one or more association packets. For example, the wearable device 204-a may transmit an association request to the AP 102 and the AP 102 may transmit an association response corresponding to the association request. In some implementations, the wearable device 204-a and the AP 102 may include an indication of the first device-specific address in both of the association request and the association response in accordance with the individual provisioning.

At 410, the wearable device 204-b and the AP 102 may communicate one or more association packets. For example, the wearable device 204-b may transmit an association request to the AP 102 and the AP 102 may transmit an association response corresponding to the association request. In some implementations, the wearable device 204-b and the AP 102 may include an indication of the second device-specific address in both of the association request and the association response in accordance with the individual provisioning.

At 412, the wearable device 204-a and the AP 102 may communicate one or more packets associated with an ARP negotiation. In some implementations, the wearable device 204-a and the AP 102 may include an indication of the first device-specific address in the one or more packets associated with the ARP negotiation in accordance with the individual provisioning.

At 414, the wearable device 204-b and the AP 102 may communicate one or more packets associated with an ARP negotiation. In some implementations, the wearable device 204-b and the AP 102 may include an indication of the second device-specific address in the one or more packets associated with the ARP negotiation in accordance with the individual provisioning.

At 416, the wearable device 204-a and the AP 102 may communicate one or more packets associated with a DHCP negotiation. In some aspects, the one or more packets associated with the DHCP negotiation may indicate, to the wearable device 204-a, a first IP address. In some implementations, the first IP address may correspond exclusively to the wearable device 204-a in accordance with the individual provisioning.

At 418, the wearable device 204-b and the AP 102 may communicate one or more packets associated with a DHCP negotiation. In some aspects, the one or more packets associated with the DHCP negotiation may indicate, to the wearable device 204-b, a second IP address. In some implementations, the second IP address may correspond exclusively to the wearable device 204-b in accordance with the individual provisioning.

In accordance with performing separate connection setup procedures, the wearable device 204-a and the wearable device 204-b may communicate with the AP 102 as two distinct devices. In some implementations, the wearable device 204-a and the wearable device 204-b may manage power consumption by individually setting a power management bit to 0 or 1 (within, for example, a QoS NULL packet) to indicate a respective power management state.

FIG. 5 shows an example flowchart 500 that supports managing a group of Wi-Fi-enabled wearable or handheld wireless devices using a shared address according to some aspects of the present disclosure. The flowchart 500 may implement or be implemented to realize or facilitate aspects of the WLAN 100, the signaling diagram 200, the process flow 300, or the process flow 400. For example, one or more wearable devices, such as the wearable device wearable device 204-a or the wearable device wearable device 204-b, may perform operations associated with the flowchart 500 to measure, receive an indication, or otherwise determine whether to employ a shared address-based provisioning mechanism (which may be referred to as vML-based provisioning) or an individual provisioning mechanism.

At 502, the wearable device may determine whether a first wireless communication link is established with at least one other wearable device of a group of wearable devices. In some implementations, for example, a group of wearable devices may establish the first wireless communication link for communication between two or more wearable devices and may use the first wireless communication link to exchange (such as transmit and/or receive) control traffic between the two or more wearable devices. Such control traffic may include a first set of packets that wearable devices exchange to negotiate, select, and/or assign a shared address and respective link IDs corresponding to each respective wearable device. For example, a set of wearable devices may piggyback additional Wi-Fi information (such as information pertaining to an XPAN) that is common to (such as applicable to) the set of wearable devices over the first wireless communication link. Such a first wireless communication link may be an example of any peer-to-peer link and may function as a “backhaul” link between two or more wearable devices. In examples in which a group of wearable devices are wireless earbuds, the first wireless communication link may be a Bluetooth link (such as a BLE link) and the wireless earbuds may perform BLE control exchanges via the first wireless communication link. In examples in which the first wireless communication link is not established, the wearable device may determine to employ an individual provisioning mechanism (at 504).

At 506, in examples in which the first wireless communication link is established, the wearable device may determine whether a wireless communication device with which the wearable device establishes a second wireless communication link is a traffic source/sink device or another wireless communication device (such as an AP 102) along a relay path between the traffic source/sink device and the wearable device. Direct communication between the wearable device and the traffic source/sink device may be referred to as point-to-point communication and indirect communication between the wearable device and the traffic source/sink device via another wireless communication device may be referred to as over-the-AP communication.

At 508, in examples in which the communication is over-the-AP, the wearable device may perform one or more operations associated with a candidate AP selection. For example, the wearable device may select a candidate AP 102 for routing traffic between the wearable device and the traffic source/sink device.

At 510, the wearable device may determine whether the candidate AP 102 supports wireless multi-media (WMM). In examples in which the candidate AP 102 does not support WMM, the wearable device may employ an individual provisioning mechanism (at 504).

At 512, in examples in which the candidate AP 102 supports WMM or in examples in which the communication is point-to-point, the wearable device may negotiate primary and secondary roles with other wearable devices in the group of wearable devices. In some implementations, the wearable device may perform such negotiation by communicating (such as transmitting and/or receiving) one or more packets with other wearable devices in the group via, for example, the first wireless communication link (such as via at least one first wireless communication link).

At 514, the wearable device may further negotiate a shared address corresponding to an association of the wearable device and the other wearable devices in the group of wearable devices. Such a shared address may be understood and equivalently referred to herein as a vML address.

At 516, the wearable device may further negotiate one or more aspects associated with a scanning operation, authentication, association, EAPOL and/or security keys, ARP, and/or DHCP. In other words, for example, the wearable devices may negotiate (such as coordinate) one or more aspects associated with how a second wireless communication link with the wireless communication device is to be established.

At 518, the wearable device may determine whether the wireless communication device with which the second wireless communication link is established is present in a vML whitelist or a vML blacklist. In other words, the wearable device may determine whether the wireless communication device is present in a first list of devices (such as the vML whitelist) for which shared address-based provisioning is allowed or in a second list of devices (such as the vML blacklist) for which shared address-based provisioning is not allowed. In some implementations, the wearable device may determine whether the wireless communication device is present in one of the first list of devices or the second list of devices in accordance with searching one or both lists for an ID (or some other identification information) associated with the wireless communication device. In examples in which the wireless communication device is present in the second list of devices, the wearable device may employ an individual provisioning mechanism (at 504).

At 520, in examples in which the wireless communication device is present in the first list of devices, the wearable device may employ shared address-based provisioning (such as vML-based provisioning).

Alternatively, at 522, in examples in which the wireless communication device is not present in either the first list of devices or the second list of devices, the wearable device may perform or otherwise participate in a QoS conformance test associated with whether an end-to-end path between the wearable device and a traffic source/sink device supports QoS-based traffic prioritization. At 524, in examples in which the end-to-end path fails the QoS conformance test, the wearable device may add the wireless communication device to the second list of devices (such as the vML blacklist). At 526, in examples in which the end-to-end path passes the QoS conformance test, the wearable device may add the wireless communication device to the first list of devices (such as the vML whitelist). In accordance with such a maintenance of the first list of devices and the second list of devices, the wearable device may refrain from repeating a QoS conformance test for a wireless communication device for which a previous QoS conformance test has already been performed. In some aspects, the wearable device may maintain the first list of devices and the second list of devices for as long as the wearable device is connected to the internet (such as until the wearable device is placed into a case, runs out of battery, or otherwise disconnects). In some other aspects, the wearable device may maintain the first list of devices and the second list of devices for a threshold time period, at which time the wearable device may refresh (such as purge) the lists and subsequently build out the lists again by performing fresh QoS conformance tests.

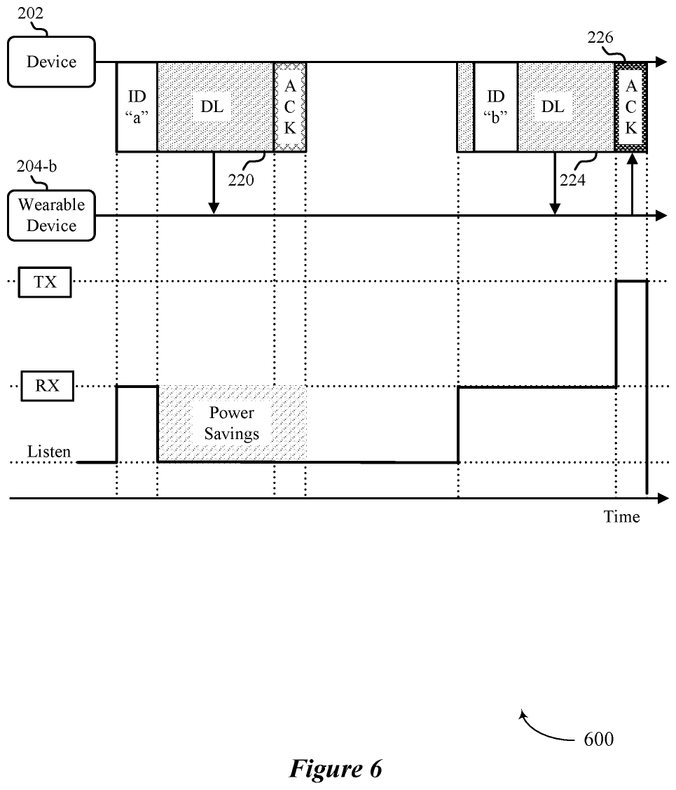

FIG. 6 shows an example communication timeline 600 that supports managing a group of Wi-Fi-enabled wearable or handheld wireless devices using a shared address according to some aspects of the present disclosure. The communication timeline 600 may implement or be implemented to realize or facilitate aspects of the WLAN 100, the signaling diagram 200, the process flow 300, the process flow 400, or the flowchart 500. For example, the communication timeline 600 illustrates communication between the wearable device 204-b and the wireless communication device 202, which may be examples of corresponding devices illustrated by and described with reference to FIGS. 2-4. In some implementations, the communication timeline 600 illustrates how the wearable device 204-b may perform link ID-based early receive termination (to save battery power).

For example, in implementations in which wearable devices of a group of wearable devices perform link ID-based early termination, a wearable device may decode or parse a portion (such as a frame header) of a packet to determine whether the packet is intended for the wearable device or another wearable device of the group. In some implementations, link ID-based early termination may be an alternative to link ID-based TWT sessions in accordance with a capability of the wireless communication device 202. For example, some APs 102 may not support TWT session setup or U-APSD, due to which link ID-based delivery over a negotiated time window may not be feasible.

Further, because power management states (which also may be referred to as power management modes) may be defined at a peer level (such as for each shared address), all wearable devices of a group of wearable devices may enter a given power management state at the same time and, because an AP 102 may deliver packets associated with all link IDs during a same awake time, each wearable device may employ an early receive termination in accordance with which link ID a given packet is associated with. In some implementations, for example, a wearable device may determine whether a packet is intended for itself or another wearable device in accordance with a link ID (such as TID or traffic class) associated with the packet. As such, the wearable device may decode packets associated with a link ID corresponding to itself and may refrain from decoding packets associated with a different link ID. In some implementations, each wearable device of a group of wearable devices may support or be configured in accordance with hardware to terminate packet reception in accordance with a programmed link ID value (such as a programmed TID or traffic class).

For example, as illustrated in the example of the communication timeline 600, the wearable device 204-b may receive a packet 220 including a frame header indicating the link ID “a,” which, in accordance with previous negotiation, the wearable device 204-b may determine as corresponding to the wearable device 204-a and not the wearable device 204-b. As such, the wearable device 204-b may refrain from decoding a data portion of the packet 220 and instead achieve some amount of power savings. For further example, the wearable device 204-b may receive a packet 224 including a frame header indicating the link ID “b,” which, in accordance with previous negotiation, the wearable device 204-b may determine as corresponding to the wearable device 204-b. As such, the wearable device 204-b may decode a data portion of the packet 224 and, in examples in which the decoding is successful, may transmit an ACK 226 associated with the packet 224 to the wireless communication device 202. In some implementations, the wearable device 204-b may obtain an indication of the link ID associated with a given packet in accordance with a TID value in the frame header, such as a TID value in a QoS Control field of the frame header.

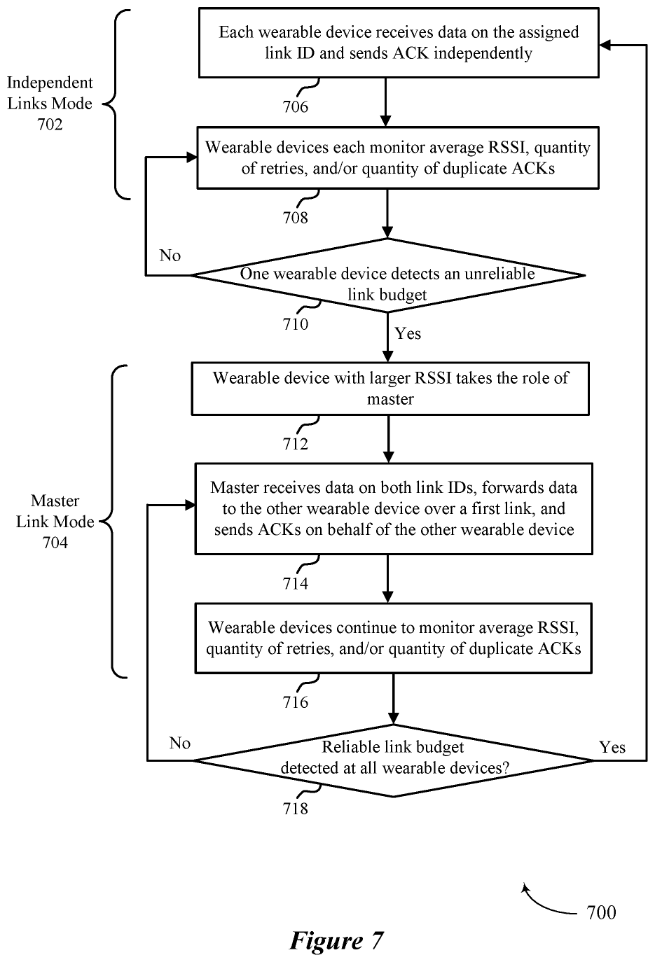

FIG. 7 shows an example flowchart 700 that supports managing a group of Wi-Fi-enabled wearable or handheld wireless devices using a shared address according to some aspects of the present disclosure. The flowchart 700 may implement or be implemented to realize or facilitate aspects of the WLAN 100, the signaling diagram 200, the process flow 300, the process flow 400, the flowchart 500, or the communication timeline 600. For example, the flowchart 700 illustrates one or more operations that one or more wearable devices of a group of wearable devices may perform to maintain reliable transmission and/or reception of data. In some implementations, for example, a group of wearable devices may operate in accordance with an independent links mode 702 according to which each wearable device of the group receives and acknowledges packets associated with its unique link ID and a master link mode 704 according to which one wearable device receives and acknowledges packets associated with its own unique link ID as well as packets associated with another link ID corresponding to another wearable device of the group. The group of wearable devices may transition or switch between the independent links mode 702 and the master link mode 704 in accordance with whether one or more link quality metrics satisfy one or more conditions.

For example, while a group of wearable devices may be collocated and within approximately a same or similar distance from a traffic source/sink device or another wireless communication device along a multi-hop relay path, each wearable device may be a distinct physical device and, likewise, may have differing link conditions. For example, different wearable devices of a group of wearable devices may have different channel states and/or different signal-to-interference plus noise ratio (SINR) measurements, which may lead to considerations on a link-by-link basis associated with downlink rate adaptation and receive signal strength indicator (RSSI) monitoring.

In implementations in which a group of wearable devices are connected to an MLO-capable wireless communication device, each link of the MLO-capable wireless communication device may monitor downlink rate adaptation and RSSI via, for example, packet error rate (PER) tracking for rate adaptation on a link-by-link basis. Additionally, a connected wireless communication device may perform beamforming on each link or frequency independently, such as in accordance with coordinated beamforming (CBF) generation by each wearable device independently and steering from the connected wireless communication device to each wearable device (which may appear as two links of a same MLD for an MLO-capable wireless communication device).

Alternatively, in implementations in which a group of wearable devices are not connected to an MLO-capable wireless communication device, each wearable device may track and detect asymmetry in link condition (such as on a link ID-by-link ID basis) and the group of wearable devices may switch between the independent links mode 702 and the master link mode 704 when link quality metrics indicate or suggest a link asymmetry large enough to cause a measurable different in link quality. In other words, the group of wearable devices may switch to the master link mode 704 during an asymmetry period (such as a time period during which a first link of a first wearable device of the group is associated with first link quality metrics more than a threshold different than second link quality metrics associated with a second link of a second wearable device of the group).

At 706, for example, each wearable device of a group of wearable devices may receive data (such as packets) associated with an assigned link ID and may transmit feedback information (such as an ACK) independently.

At 708, each wearable device of the group of wearable devices may monitor one or more of an average RSSI, a quantity of retries (such as downlink and/or uplink retries), or a quantity of duplicate ACKs associated with communication between that wearable device and the wireless communication device to which the group of wearable devices is connected.

At 710, each wearable device of the group of wearable devices may determine whether a corresponding link is associated with an unreliable link budget. In examples in which no wearable device of the group of wearable devices detects an unreliable link budget, each wearable device of the group of wearable devices may continue monitoring the average RSSI, the quantity of retries, or the quantity of duplicate ACKs between that wearable device and the wireless communication device to which the group of wearable devices is connected (at 708). In some implementations, the group of wearable devices may periodically share information associated with average RSSIs, quantities of retries, and/or quantities of duplicate ACKs with each other via at least one first wireless communication link between wearable devices of the group of wearable devices.

At 712, in examples in which at least one wearable device detects an unreliable link budget, the group of wearable devices (or at least a subset of the group of wearable devices) may transition from the independent links mode 702 to the master link mode 704 and a wearable device with a relatively larger RSSI may take the role of master in accordance with the transition. For example, a first wearable device may take the role of master with respect to a second wearable device that detects an unreliable link budget. In some implementations, a wearable device may detect an unreliable link budget in accordance with measuring a delta between, for example, a first average RSSI measured by the first wearable device and a second average RSSI measured by the second wearable device. In other words, in examples in which the delta between the average RSSIs of the first wearable device and the second wearable device exceeds a threshold, one or both of the first wearable device and the second wearable device may detect an asymmetric link budget and may trigger or identify an unreliable link budget condition for the second wearable device (such as the wearable device with the smaller RSSI). In some other implementations, one or both of the first wearable device and the second wearable device may trigger or identify an unreliable link budget condition in examples in which a quantity of retries (such as downlink retries for packets from a traffic source device or a relay wireless communication device) and/or duplicate ACKs (for packets received by a wearable device but for which corresponding ACKs are unsuccessfully received by a traffic source device or a relay wireless communication device) increase above a threshold, and/or in examples in which an absolute RSSI for a wearable device falls below a threshold.

At 714, the first wearable device (such as the master) may receive and decode first packets associated with its own link ID as well as second packets associated with a link ID corresponding to the second wearable device and may forward (such as relay) data received via the second packets to the second wearable device via the first wireless communication link between the first wearable device and the second wearable device. The second wearable device may receive the data from the first wearable device and may transmit feedback information associated with the data to the first wearable device, which the first wearable device may transmit, via one or more BAs, to the wireless communication device to which the group of wearable devices is connected. In other words, the first wearable device may transmit one or more ACKs on behalf of the second wearable device, in addition to transmitting one or more ACKs for packets associated with the link ID corresponding to the first wearable device.

At 716, both the first wearable device and the second wearable device may continue monitoring an average RSSI, a quantity of retries, and/or a quantity of duplicate ACKs while operating in accordance with the master link mode 704. In some implementations, the group of wearable devices may periodically share information associated with average RSSIs, quantities of retries, and/or quantities of duplicate ACKs with each other via at least one first wireless communication link between wearable devices of the group of wearable devices.

At 718, each wearable device of the group of wearable devices (including, notably, the second wearable device) may determine whether a corresponding link is associated with an unreliable link budget. In examples in which at least one wearable devices does not have a reliable link budget (such as in examples in which the second wearable device still detects an unreliable link budget), the first wearable device may continue operating as a master and may continue receiving packets associated with multiple different link IDs (for forwarding to one or more wearable devices still suffering from an unreliable link budget). Alternatively, in examples in which all wearable devices of the group of wearable devices detect a reliable link budget (in examples in which link conditions at the second wearable device improve), the group of wearable devices may transition from the master link mode 704 to the independent links mode 702. Further, independent of the group of wearable devices switching between the independent links mode 702 and the master link mode 704, the wireless communication device to which the group of wearable devices is connected by perform rate adaptation on a link-by-link (such as TID-by-TID) basis.

In some implementations, in the master link mode 704, a master wearable device may stay awake for more time, forward data to at least one other wearable device, and send ACK(s) on behalf of at least one other wearable device. As such, the master wearable device may experience relatively greater power consumption in the master link mode 704 and, in some implementations, may support one or more mechanisms to mitigate how long the group of wearable devices is in the master link mode 704. For example, to facilitate a switching from the master link mode 704 to the independent links mode 702, a master wearable device may transmit an indication of a recommended coding rate, such as a recommend modulation and coding scheme (MCS), for a wearable device suffering from an unreliable link budget. In such examples, the recommended coding rate may be for both communication between the master wearable device and the wireless communication device and communication between the wearable device suffering from the unreliable link budget and the wireless communication device.

The master wearable device may indicate the recommended coding rate via various packet types, such as via a QoS null packet or any type of management frame sent to the wireless communication device. In some implementations, via which field the master wearable device indicates the recommended coding rate may vary in accordance with a capability of the master wearable device and/or of the wireless communication device. For high throughput (HT), for example, the master wearable device may indicate the recommended coding rate in an MCS feedback (MFB)/antenna selection (ASELC) field in a link adaptation control field in HT control. For very high throughput (VHT), the master wearable device may indicate the recommended coding rate in a VHT-MCS field in the MFB field in the VHT variant HT control field. For high efficiency (HE), the master wearable device may indicate the recommended coding rate in an HE-MCS field in an HE link adaptation (HLA) control field. For extremely high throughput (EHT), the master wearable device may indicate the recommended coding rate in an EHT-MCS field in the EHT link adaptation (ELA) control field. The wireless communication device receiving the indication of the recommended coding rate may update one or more link parameters (such as an MCS value) for communication with the master wearable device and one or more other wearable devices in the group of wearable devices in accordance with the indication.

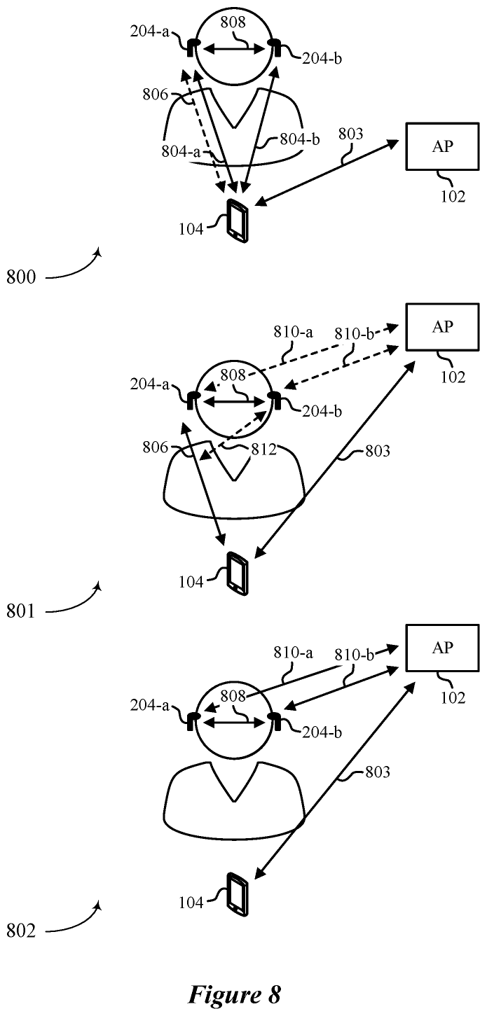

FIG. 8 shows example XPAN topologies 800, 801, and 802 that support managing a group of Wi-Fi-enabled wearable or handheld wireless devices using a shared address according to some aspects of the present disclosure. The XPAN topologies 800, 801, and 802 may implement or be implemented to realize or facilitate aspects of the WLAN 100, the signaling diagram 200, the process flow 300, the process flow 400, the flowchart 500, the communication timeline 600, or the flowchart 700. For example, each of the XPAN topologies 800, 801, and 802 illustrate example deployment scenarios of one or more STAs 104, one or more APs 102, the wearable device 204-a, and the wearable device 204-b.

As illustrated by the XPAN topology 800, the AP 102 may communicate with the STA 104 via a link 803 and the STA 104 may communicate with the wearable device 204-a and the wearable device 204-b via a link 804-a and a link 804-b, respectively. The link 803 may be an example of a 2.4 GHz link and the link 804-a and the link 804-b may be examples of 5 GHz links. The STA 104 also may communicate with the wearable device 204-a via a link 806, which may be an example of a Bluetooth link. The wearable device 204-a and the wearable device 204-b may communicate with each other via a link 808, which may be an example of a Bluetooth link. The link 804-a and the link 804-b may be examples of XPAN links and the XPAN topology 800 may be an example of an XPAN direct link.

As illustrated by the XPAN topology 801, the AP 102 may communicate with the STA 104 via the link 803 and the AP 102 may communicate with the wearable device 204-a and the wearable device 204-b via a link 810-a and a link 810-b, respectively. The link 803, the link 810-a, and the link 810-b may be examples of 5 GHz links. The STA 104 may communicate with the wearable device 204-a via a link 806, which may be an example of a Bluetooth link. The wearable device 204-a and the wearable device 204-b may communicate with each other via the link 808, which may be an example of a Bluetooth link. In some implementations, the wearable device 204-b may support a mirroring technology and may attempt to “sniff” packets sent via the link 806 via a mirroring link 812. The link 803, the link 810-a, and the link 810-b may be examples of XPAN links and the XPAN topology 801 may be an example of an XPAN infrastructure link on standby.

As illustrated by the XPAN topology 802, the AP 102 may communicate with the STA 104 via the link 803 and the AP 102 may communicate with the wearable device 204-a and the wearable device 204-b via the link 810-a and the link 810-b, respectively. The link 803, the link 810-a, and the link 810-b may be examples of 5 GHz links. The wearable device 204-a and the wearable device 204-b may communicate with each other via the link 808, which may be an example of a Bluetooth link. The STA 104 may lack a direct link between the STA 104 and the earbuds. Instead, the AP 102 may control the system or relay packets and messages between the earbuds and the STA 104. The link 803, the link 810-a, and the link 810-b may be examples of XPAN links and the XPAN topology 802 may be an example of an XPAN infrastructure deployment.

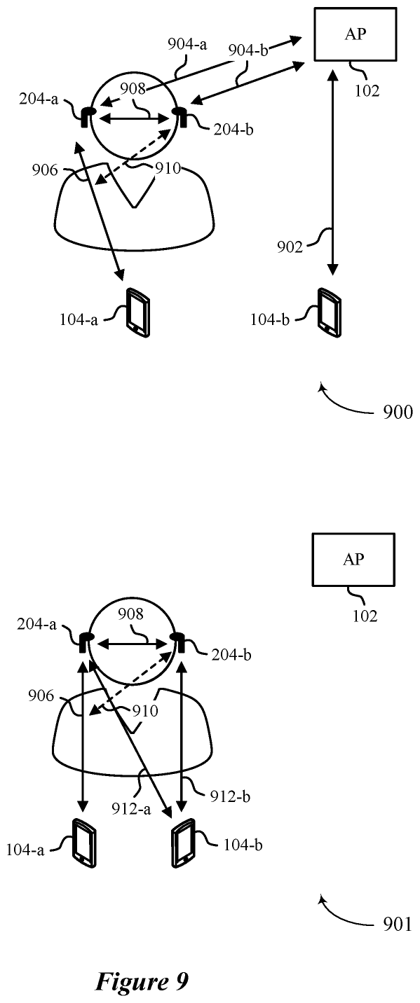

FIG. 9 shows example XPAN topologies 900 and 901 that support managing a group of Wi-Fi-enabled wearable or handheld wireless devices using a shared address according to some aspects of the present disclosure. The XPAN topologies 900 and 901 may implement or be implemented to realize or facilitate aspects of the WLAN 100, the signaling diagram 200, the process flow 300, the process flow 400, the flowchart 500, the communication timeline 600, or the flowchart 700. For example, each of the XPAN topologies 900 and 901 illustrate example deployment scenarios of one or more STAs 104, one or more APs 102, the wearable device 204-a, and the wearable device 204-b.

As illustrated by the XPAN topology 900, the AP 102 may communicate with the STA 104-b via a link 902 and the AP 102 may communicate with the wearable device 204-a and the wearable device 204-b via a link 904-a and a link 904-b, respectively. The link 902, the link 904-a, and the link 904-b may be examples of 5 GHz links. The STA 104-a may communicate with the wearable device 204-a via a link 906, which may be an example of a Bluetooth link. The wearable device 204-a and the wearable device 204-b may communicate with each other via the link 908, which may be an example of a Bluetooth link. In some implementations, the wearable device 204-b may support a mirroring technology and may attempt to “sniff” packets sent via the link 806 via a mirroring link 910. The link 902, the link 904-a, and the link 904-b may be examples of XPAN links and the XPAN topology 900 may be an example of a Bluetooth+XPAN (infrastructure) dual link.

As illustrated by the XPAN topology 901, the AP 102 may lack a connection to other devices. In such examples, the STA 104-a may communicate with the wearable device 204-a via the link 906 and the wearable device 204-a and the wearable device 204-b may communicate with each other via the link 908, and each of the link 906 and the link 908 may be examples of Bluetooth links. In some implementations, the wearable device 204-b may support a mirroring technology and may attempt to “sniff” packets sent via the link 806 via a mirroring link 910. The STA 104-b may communicate with the wearable device 204-a and the wearable device 204-b via a link 912-a and a link 912-b, respectively. The link 912-a and the link 912-b may be examples of 5 GHz links. The link 912-a and the link 912-b may be examples of XPAN links and the XPAN topology 901 may be an example of a Bluetooth+XPAN (direct) dual link.

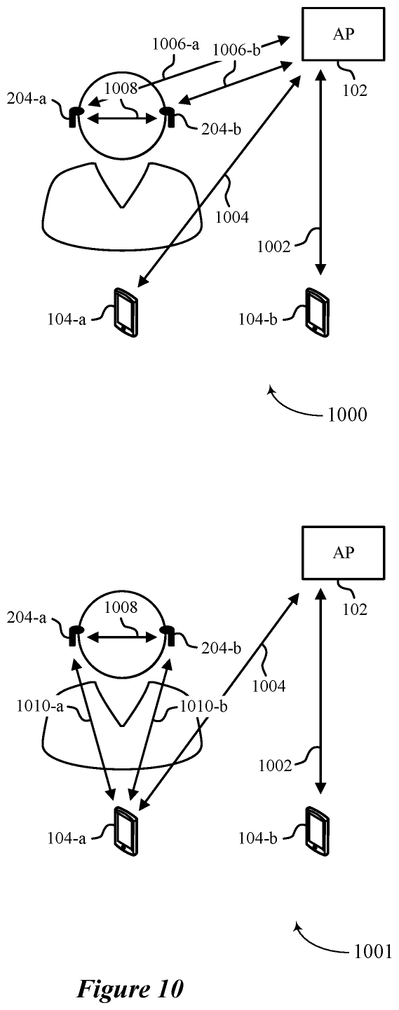

FIG. 10 shows example XPAN topologies 1000 and 1001 that support managing a group of Wi-Fi-enabled wearable or handheld wireless devices using a shared address according to some aspects of the present disclosure. The XPAN topologies 1000 and 1001 may implement or be implemented to realize or facilitate aspects of the WLAN 100, the signaling diagram 200, the process flow 300, the process flow 400, the flowchart 500, the communication timeline 600, or the flowchart 700. For example, each of the XPAN topologies 1000 and 1001 illustrate example deployment scenarios of one or more STAs 104, one or more APs 102, the wearable device 204-a, and the wearable device 204-b.

As illustrated by the XPAN topology 1000, the AP 102 may communicate with the STA 104-b via a link 1002 and may communicate with the STA 104-a via a link 1004. The link 1002 and the link 1004 may be examples of 5 GHz links. The AP 102 also may communicate with the wearable device 204-a and the wearable device 204-b via a link 1006-a and a link 1006-b, respectively. The link 1006-a and the link 1006-b may be examples of 5 GHz links. The wearable device 204-a and the wearable device 204-b may communicate with each other via a link 1008, which may be an example of a Bluetooth link. The link 1002, the link 1004, the link 1006-a, and the link 1006-b may be examples of XPAN links and the XPAN topology 1000 may be an example of an XPAN+XPAN dual link.

As illustrated by the XPAN topology 1001, the AP 102 may communicate with the STA 104-b via the link 1002 and may communicate with the STA 104-a via the link 1004. The link 1002 and the link 1004 may be examples of 5 GHz links. The STA 104-a may communicate with the wearable device 204-a and the wearable device 204-b via a link 1010-a and a link 1010-b, respectively. The link 1010-a and the link 1010-b may be examples of 5 GHz links. The wearable device 204-a and the wearable device 204-b may communicate with each other via the link 1008, which may be an example of a Bluetooth link. The link 1002, the link 1004, the link 1010-a, and the link 1010-b may be examples of XPAN links and the XPAN topology 1001 may be an example of an XPAN direct dual link.

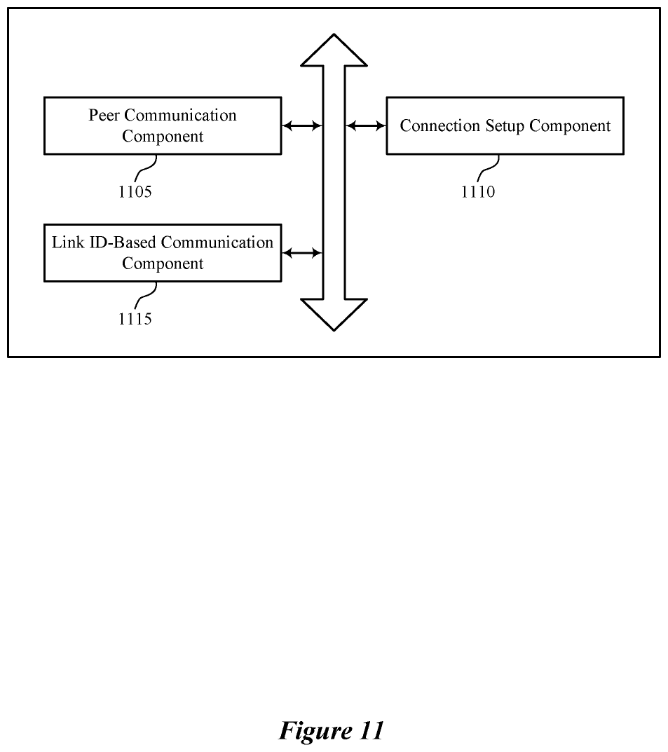

FIG. 11 shows a block diagram of an example wireless communication device that supports managing a group of Wi-Fi-enabled wearable or handheld wireless devices using a shared address. In various examples, the wireless communication device can be a chip, SoC, chipset, package or device that may include: one or more modems (such as, a Wi-Fi (IEEE 802.11) modem or a cellular modem such as 3GPP 4G LTE or 5G compliant modem); one or more processors, processing blocks or processing elements (collectively “at least one processor”); one or more radios (collectively “at least one radio”); and one or more memories or memory blocks (collectively “at least one memory”). In some implementations, the at least one processor may include multiple processors, and the at least one memory may include multiple memories. One or more of the multiple processors may be coupled with one or more of the multiple memories which may, individually or collectively, be configured to perform various functions described herein (as part of a processing system).

In some implementations, the wireless communication device can be a device for use in a STA or a wearable device, such as STA 104 described with reference to FIG. 1 or one or both of a wearable device 204-a and a wearable device 204-b as described with reference to FIG. 2. In some aspects, a STA 104 may be an example of a wearable device. In some other examples, the wireless communication device can be a STA that includes such a chip, SoC, chipset, package or device as well as multiple antennas. The wireless communication device is capable of transmitting and receiving wireless communication in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some implementations, the wireless communication device also includes or can be coupled with at least one application processor which may be further coupled with at least one memory. In some implementations, the wireless communication device further includes a user interface (UI) (such as a touchscreen or keypad) and a display, which may be integrated with the UI to form a touchscreen display. In some implementations, the wireless communication device may further include one or more sensors such as, for example, one or more inertial sensors, accelerometers, temperature sensors, pressure sensors, or altitude sensors.

The wireless communication device includes a peer communication component 1105, a connection setup component 1110, and a link ID-based communication component 1115. Portions of one or more of the peer communication component 1105, the connection setup component 1110, and the link ID-based communication component 1115 may be implemented at least in part in hardware or firmware. For example, one or more of the peer communication component 1105, the connection setup component 1110, and the link ID-based communication component 1115 may be implemented at least in part by at least one modem. In some implementations, at least some of the peer communication component 1105, the connection setup component 1110, and the link ID-based communication component 1115 are implemented at least in part by at least one processor and as software stored in at least one memory. For example, portions of one or more of the peer communication component 1105, the connection setup component 1110, and the link ID-based communication component 1115 can be implemented as non-transitory instructions (or “code”) executable by the at least one processor to perform the functions or operations of the respective module.

In some implementations, the at least one processor may be a component of a processing system. A processing system may generally refer to a system or series of machines or components that receives inputs and processes the inputs to produce a set of outputs (which may be passed to other systems or components of, for example, the wireless communication device). For example, a processing system of the wireless communication device may refer to a system including the various other components or subcomponents of the wireless communication device, such as the at least one processor, or at least one transceiver, or at least one communication manager, or other components or combinations of components of the wireless communication device. The processing system of the wireless communication device may interface with other components of the wireless communication device, and may process information received from other components (such as inputs or signals) or output information to other components. For example, a chip or modem of the wireless communication device may include a processing system, a first interface to output information and a second interface to obtain information. In some implementations, the first interface may refer to an interface between the processing system of the chip or modem and a transmitter, such that the wireless communication device may transmit information output from the chip or modem. In some implementations, the second interface may refer to an interface between the processing system of the chip or modem and a receiver, such that the wireless communication device may obtain information or signal inputs, and the information may be passed to the processing system. A person having ordinary skill in the art will readily recognize that the first interface also may obtain information or signal inputs, and the second interface also may output information or signal outputs.

The wireless communication device may support wireless communication at a first wearable or handheld wireless device in accordance with examples as disclosed herein. The peer communication component 1105 is capable of, configured to, or operable to support a means for communicating, with at least a second wearable or handheld wireless device via a first wireless communication link, one or more first packets associated with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device. The connection setup component 1110 is capable of, configured to, or operable to support a means for transmitting, in association with establishing a second wireless communication link with a wireless communication device, one or more second packets indicating the shared address, the first link identifier, and the second link identifier. The link ID-based communication component 1115 is capable of, configured to, or operable to support a means for receiving, from the wireless communication device via the second wireless communication link, one or more third packets associated with the first link identifier.

In some implementations, to support communicating the one or more first packets with at least the second wearable or handheld wireless device via the first wireless communication link, the peer communication component 1105 is capable of, configured to, or operable to support a means for transmitting one or more of the one or more first packets to, and receiving one or more of the one or more first packets from, the second wearable or handheld wireless device in accordance with a negotiation of the shared address with the second wearable or handheld wireless device.

In some implementations, to support communicating the one or more first packets with at least the second wearable or handheld wireless device via the first wireless communication link, the peer communication component 1105 is capable of, configured to, or operable to support a means for transmitting one or more of the one or more first packets to, and receiving one or more of the one or more first packets from, the second wearable or handheld wireless device in accordance with an assignment of the first link identifier to the first wearable or handheld wireless device and the second link identifier to the second wearable or handheld wireless device.

In some implementations, the link ID-based communication component 1115 is capable of, configured to, or operable to support a means for transmitting, to the wireless communication device, a fourth packet in association with an establishment of a first block acknowledgment session between the wireless communication device and the first wearable or handheld wireless device, the fourth packet including an indication of the first link identifier. In some implementations, the link ID-based communication component 1115 is capable of, configured to, or operable to support a means for transmitting, to the wireless communication device, one or more block acknowledgments associated with the one or more third packets.

In some implementations, the link ID-based communication component 1115 is capable of, configured to, or operable to support a means for transmitting, to the wireless communication device, a fourth packet indicating the shared address and a power management state corresponding to the shared address.

In some implementations, the peer communication component 1105 is capable of, configured to, or operable to support a means for receiving, from the second wearable or handheld wireless device via the first wireless communication link, a fifth packet indicating that the second wearable or handheld wireless device is in the power management state, where transmitting the fourth packet indicating the power management state is in association with receiving the fifth packet.

In some implementations, the peer communication component 1105 is capable of, configured to, or operable to support a means for communicating, with at least the second wearable or handheld wireless device via the first wireless communication link, one or more fourth packets in accordance with a negotiation of one or more of: one or more security keys associated with communication with the wireless communication device, a dynamic host configuration protocol address, or one or more address resolution protocol tables, where the first wearable or handheld wireless device establishes the second wireless communication link in accordance with the negotiation.

In some implementations, the link ID-based communication component 1115 is capable of, configured to, or operable to support a means for receiving, from the wireless communication device, information indicative of a schedule of communication time intervals corresponding to the first link identifier. In some implementations, the link ID-based communication component 1115 is capable of, configured to, or operable to support a means for monitoring the second wireless communication link in accordance with the schedule of the communication time intervals, where receiving the one or more third packets is in association with monitoring the second wireless communication link.

In some implementations, each of the one or more third packets includes a respective frame header indicating the first link identifier, and the link ID-based communication component 1115 is capable of, configured to, or operable to support a means for decoding data portions of the one or more third packets in accordance with frame headers of the one or more third packets indicating the first link identifier. In some implementations, each of the one or more third packets includes a respective frame header indicating the first link identifier, and the link ID-based communication component 1115 is capable of, configured to, or operable to support a means for receiving one or more fourth packets each including a respective frame header indicating the second link identifier. In some implementations, each of the one or more third packets includes a respective frame header indicating the first link identifier, and the link ID-based communication component 1115 is capable of, configured to, or operable to support a means for refraining from decoding data portions of the one or more fourth packets in accordance with frame headers of the one or more fourth packets indicating the second link identifier.

In some implementations, the link ID-based communication component 1115 is capable of, configured to, or operable to support a means for receiving, from the wireless communication device, information indicative of a first mapping of the first link identifier to the second wireless communication link and a second mapping of the second link identifier to a third wireless communication link. In some implementations, the link ID-based communication component 1115 is capable of, configured to, or operable to support a means for tuning at least one radio to the second wireless communication link in accordance with the first mapping, where receiving the one or more third packets is in association with tuning the at least one radio to the second wireless communication link, and where the second wireless communication link is associated with a first frequency channel and the third wireless communication link is associated with a second frequency channel different than the first frequency channel.

In some implementations, the connection setup component 1110 is capable of, configured to, or operable to support a means for receiving an indication that the wireless communication device is capable of quality of service-based traffic flow prioritization. In some implementations, the connection setup component 1110 is capable of, configured to, or operable to support a means for establishing the second wireless communication link with the wireless communication device using the shared address in accordance with the wireless communication device being capable of the quality of service-based traffic flow prioritization.

In some implementations, to support receiving the indication that the wireless communication device is capable of the quality of service-based traffic flow prioritization, the connection setup component 1110 is capable of, configured to, or operable to support a means for receiving identification information of the wireless communication device, where the identification information indicates that the wireless communication device is present in a first list of devices for which use of the shared address is allowed and absent from a second list of devices for which use of the shared address is not allowed.

In some implementations, a presence of the identification information of the wireless communication device in either the first list of devices or the second list of devices is indicative of a previous quality of service conformance test for the wireless communication device. In some implementations, being present in the first list of devices is indicative of a successful quality of service conformance test and being present in the second list of devices is indicative of an unsuccessful quality of service conformance test.

In some implementations, to support receiving the indication that the wireless communication device is capable of the quality of service-based traffic flow prioritization, the connection setup component 1110 is capable of, configured to, or operable to support a means for receiving a packet indicating that an end-to-end path between a traffic source device and the first wearable or handheld wireless device is capable of the quality of service-based traffic flow prioritization, where the wireless communication device is the traffic source device or another wireless communication device along the end-to-end path.

In some implementations, the peer communication component 1105 is capable of, configured to, or operable to support a means for communicating, with the second wearable or handheld wireless device via the first wireless communication link, information indicative of one or more link quality metrics pertaining to first communication between the first wearable or handheld wireless device and the wireless communication device and second communication between the second wearable or handheld wireless device and the wireless communication device.

In some implementations, the peer communication component 1105 is capable of, configured to, or operable to support a means for receiving an indication that a link quality metric pertaining to the second communication between the second wearable or handheld wireless device and the wireless communication device fails to satisfy a condition. In some implementations, the link ID-based communication component 1115 is capable of, configured to, or operable to support a means for receiving one or more fourth packets including the second link identifier in accordance with the link quality metric failing to satisfy the condition. In some implementations, the link ID-based communication component 1115 is capable of, configured to, or operable to support a means for transmitting, to the second wearable or handheld wireless device via the first wireless communication link, data received via the one or more fourth packets in accordance with the one or more fourth packets including the second link identifier.

In some implementations, the peer communication component 1105 is capable of, configured to, or operable to support a means for receiving, from the second wearable or handheld wireless device via the first wireless communication link, feedback information associated with the data. In some implementations, the link ID-based communication component 1115 is capable of, configured to, or operable to support a means for transmitting, to the wireless communication device, one or more block acknowledgments associated with the one or more fourth packets, the one or more block acknowledgments indicating the feedback information received from the second wearable or handheld wireless device.

In some implementations, the peer communication component 1105 is capable of, configured to, or operable to support a means for receiving an indication that the link quality metric pertaining to the second communication between the second wearable or handheld wireless device and the wireless communication device satisfies the condition. In some implementations, the peer communication component 1105 is capable of, configured to, or operable to support a means for refraining from decoding any packets including the second link identifier in accordance with the link quality metric satisfying the condition, where the first wearable or handheld wireless device temporarily receives the one or more fourth packets including the second link identifier while the link quality metric fails to satisfy the condition.

In some implementations, the link ID-based communication component 1115 is capable of, configured to, or operable to support a means for transmitting, to the wireless communication device in accordance with the link quality metric failing to satisfy the condition, information indicative of a recommended coding rate.

In some implementations, the recommended coding rate is for both the first communication between the first wearable or handheld wireless device and the wireless communication device and the second communication between the second wearable or handheld wireless device and the wireless communication device.

In some implementations, the peer communication component 1105 is capable of, configured to, or operable to support a means for transmitting an indication that a link quality metric pertaining to the first communication between the first wearable or handheld wireless device and the wireless communication device fails to satisfy a condition. In some implementations, the peer communication component 1105 is capable of, configured to, or operable to support a means for receiving data from the second wearable or handheld wireless device via the first wireless communication link in accordance with the link quality metric failing to satisfy the condition. In some implementations, the peer communication component 1105 is capable of, configured to, or operable to support a means for transmitting, to the second wearable or handheld wireless device via the first wireless communication link, feedback information associated with the data.

In some implementations, the peer communication component 1105 is capable of, configured to, or operable to support a means for transmitting an indication that the link quality metric pertaining to the first communication between the first wearable or handheld wireless device and the wireless communication device satisfies the condition. In some implementations, the link ID-based communication component 1115 is capable of, configured to, or operable to support a means for receiving, via the second wireless communication link, packets including the first link identifier in accordance with the link quality metric satisfying the condition, where reception of any packets via the second wireless communication link is temporarily paused while the link quality metric fails to satisfy the condition.

In some implementations, the connection setup component 1110 is capable of, configured to, or operable to support a means for receiving an indication of a handover of the first wearable or handheld wireless device from the wireless communication device to a second wireless communication device. In some implementations, the connection setup component 1110 is capable of, configured to, or operable to support a means for receiving an indication that the second wireless communication device is incapable of quality of service-based traffic flow prioritization. In some implementations, the link ID-based communication component 1115 is capable of, configured to, or operable to support a means for transmitting, in association with establishing a third wireless communication link with the second wireless communication device, one or more fourth packets indicating a device-specific address, the third wireless communication link being exclusively for the first wearable or handheld wireless device in accordance with the one or more fourth packets indicating the device-specific address.

In some implementations, the first link identifier and the second link identifier are associated with a same channel access category.

In some implementations, the one or more third packets include indications of a first type of service for the first wearable or handheld wireless device, the first type of service being mapped to the first link identifier.

In some implementations, the one or more second packets include one or more of an authentication frame, an association frame, an address resolution protocol frame, a dynamic host configuration protocol frame, an extensible authentication protocol over local area network frame, a key handshake frame, and an add block acknowledgment frame.

In some implementations, communication of the one or more first packets with the second wearable or handheld wireless device indicates, to the second wearable or handheld wireless device, to refrain from separately establishing a wireless communication link with the wireless communication device.

In some implementations, the first wireless communication link is a secure peer-to-peer link and the second wireless communication link is a wireless local area network link.

In some implementations, the wireless communication device is a traffic source device, an access point, or a compute device.

Additionally, or alternatively, the wireless communication device may support wireless communication at a first wearable or handheld wireless device in accordance with examples as disclosed herein. In some implementations, the peer communication component 1105 is capable of, configured to, or operable to support a means for communicating, with at least a second wearable or handheld wireless device via a first wireless communication link, one or more first packets associated with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device. In some implementations, the link ID-based communication component 1115 is capable of, configured to, or operable to support a means for receiving, from a wireless communication device via a second wireless communication link, one or more second packets associated with the first link identifier, the second wireless communication link being in association with an establishment using the shared address.

In some implementations, to support communicating the one or more first packets with at least the second wearable or handheld wireless device via the first wireless communication link, the peer communication component 1105 is capable of, configured to, or operable to support a means for transmitting one or more of the one or more first packets to, and receiving one or more of the one or more first packets from, the second wearable or handheld wireless device in accordance with a negotiation of the shared address with the second wearable or handheld wireless device.

In some implementations, to support communicating the one or more first packets with at least the second wearable or handheld wireless device via the first wireless communication link, the peer communication component 1105 is capable of, configured to, or operable to support a means for transmitting one or more of the one or more first packets to, and receiving one or more of the one or more first packets from, the second wearable or handheld wireless device in accordance with an assignment of the first link identifier to the first wearable or handheld wireless device and the second link identifier to the second wearable or handheld wireless device.

In some implementations, the link ID-based communication component 1115 is capable of, configured to, or operable to support a means for transmitting, to the wireless communication device, a third packet in association with an establishment of a first block acknowledgment session between the wireless communication device and the first wearable or handheld wireless device, the third packet including an indication of the first link identifier. In some implementations, the link ID-based communication component 1115 is capable of, configured to, or operable to support a means for transmitting, to the wireless communication device, one or more block acknowledgments associated with the one or more second packets.

In some implementations, the peer communication component 1105 is capable of, configured to, or operable to support a means for communicating, with at least the second wearable or handheld wireless device via the first wireless communication link, one or more third packets in accordance with a negotiation of one or more of: one or more security keys associated with communication with the wireless communication device, a dynamic host configuration protocol address, or one or more address resolution protocol tables, where the second wearable or handheld wireless device establishes the second wireless communication link in accordance with the negotiation.

In some implementations, the link ID-based communication component 1115 is capable of, configured to, or operable to support a means for receiving, from the wireless communication device, information indicative of a schedule of communication time intervals corresponding to the first link identifier. In some implementations, the link ID-based communication component 1115 is capable of, configured to, or operable to support a means for monitoring the second wireless communication link in accordance with the schedule of the communication time intervals, where receiving the one or more second packets is in association with monitoring the second wireless communication link.

In some implementations, each of the one or more second packets includes a respective frame header indicating the first link identifier, and the link ID-based communication component 1115 is capable of, configured to, or operable to support a means for decoding data portions of the one or more second packets in accordance with frame headers of the one or more second packets indicating the first link identifier. In some implementations, each of the one or more second packets includes a respective frame header indicating the first link identifier, and the link ID-based communication component 1115 is capable of, configured to, or operable to support a means for receiving one or more third packets each including a respective frame header indicating the second link identifier. In some implementations, each of the one or more second packets includes a respective frame header indicating the first link identifier, and the link ID-based communication component 1115 is capable of, configured to, or operable to support a means for refraining from decoding data portions of the one or more third packets in accordance with frame headers of the one or more third packets indicating the second link identifier.

In some implementations, the link ID-based communication component 1115 is capable of, configured to, or operable to support a means for receiving, from the wireless communication device, information indicative of a first mapping of the first link identifier to the second wireless communication link and a second mapping of the second link identifier to a third link. In some implementations, the link ID-based communication component 1115 is capable of, configured to, or operable to support a means for tuning at least one radio to the second wireless communication link in accordance with the first mapping, where receiving the one or more second packets is in association with tuning the at least one radio to the second wireless communication link, and where the second wireless communication link is associated with a first frequency channel and the third link is associated with a second frequency channel different than the first frequency channel.

In some implementations, the peer communication component 1105 is capable of, configured to, or operable to support a means for communicating, with the second wearable or handheld wireless device via the first wireless communication link, information indicative of one or more link quality metrics pertaining to first communication between the first wearable or handheld wireless device and the wireless communication device and second communication between the second wearable or handheld wireless device and the wireless communication device.

In some implementations, the peer communication component 1105 is capable of, configured to, or operable to support a means for receiving an indication that a link quality metric pertaining to the second communication between the second wearable or handheld wireless device and the wireless communication device fails to satisfy a condition. In some implementations, the link ID-based communication component 1115 is capable of, configured to, or operable to support a means for receiving one or more third packets including the second link identifier in accordance with the link quality metric failing to satisfy the condition. In some implementations, the peer communication component 1105 is capable of, configured to, or operable to support a means for transmitting, to the second wearable or handheld wireless device via the first wireless communication link, data received via the one or more third packets in accordance with the one or more third packets including the second link identifier.

In some implementations, the peer communication component 1105 is capable of, configured to, or operable to support a means for receiving, from the second wearable or handheld wireless device via the first wireless communication link, feedback information associated with the data. In some implementations, the link ID-based communication component 1115 is capable of, configured to, or operable to support a means for transmitting, to the wireless communication device, one or more block acknowledgments associated with the one or more third packets, the one or more block acknowledgments indicating the feedback information received from the second wearable or handheld wireless device.

In some implementations, the peer communication component 1105 is capable of, configured to, or operable to support a means for receiving an indication that the link quality metric pertaining to the second communication between the second wearable or handheld wireless device and the wireless communication device satisfies the condition. In some implementations, the peer communication component 1105 is capable of, configured to, or operable to support a means for refraining from decoding any packets including the second link identifier in accordance with the link quality metric satisfying the condition, where the first wearable or handheld wireless device temporarily receives the one or more third packets including the second link identifier while the link quality metric fails to satisfy the condition.

In some implementations, the link ID-based communication component 1115 is capable of, configured to, or operable to support a means for transmitting, to the wireless communication device in accordance with the link quality metric failing to satisfy the condition, information indicative of a recommended coding rate.

In some implementations, the recommended coding rate is for both the first communication between the first wearable or handheld wireless device and the wireless communication device and the second communication between the second wearable or handheld wireless device and the wireless communication device.

In some implementations, the peer communication component 1105 is capable of, configured to, or operable to support a means for transmitting an indication that a link quality metric pertaining to the first communication between the first wearable or handheld wireless device and the wireless communication device fails to satisfy a condition. In some implementations, the peer communication component 1105 is capable of, configured to, or operable to support a means for receiving data from the second wearable or handheld wireless device via the first wireless communication link in accordance with the link quality metric failing to satisfy the condition. In some implementations, the peer communication component 1105 is capable of, configured to, or operable to support a means for transmitting, to the second wearable or handheld wireless device via the first wireless communication link, feedback information associated with the data.

In some implementations, the peer communication component 1105 is capable of, configured to, or operable to support a means for transmitting an indication that the link quality metric pertaining to the first communication between the first wearable or handheld wireless device and the wireless communication device satisfies the condition. In some implementations, the link ID-based communication component 1115 is capable of, configured to, or operable to support a means for receiving, via the second wireless communication link, packets including the first link identifier in accordance with the link quality metric satisfying the condition, where reception of any packets via the second wireless communication link is temporarily paused while the link quality metric fails to satisfy the condition.

In some implementations, the connection setup component 1110 is capable of, configured to, or operable to support a means for receiving an indication of a handover, of the association of the wearable or handheld wireless devices including at least the first wearable or handheld wireless device and the second wearable or handheld wireless device, from the wireless communication device to a second wireless communication device. In some implementations, the connection setup component 1110 is capable of, configured to, or operable to support a means for receiving an indication that the second wireless communication device is incapable of quality of service-based traffic flow prioritization. In some implementations, the link ID-based communication component 1115 is capable of, configured to, or operable to support a means for transmitting, in association with establishing a third wireless communication link with the second wireless communication device, one or more third packets indicating a device-specific address, the third wireless communication link being exclusively for the first wearable or handheld wireless device in accordance with the one or more third packets indicating the device-specific address.

In some implementations, the first link identifier and the second link identifier are associated with a same channel access category.

In some implementations, the one or more second packets include indications of a first type of service for the first wearable or handheld wireless device, the first type of service being mapped to the first link identifier.

In some implementations, communication of the one or more first packets with the second wearable or handheld wireless device indicates, to the first wearable or handheld wireless device, to refrain from separately establishing a wireless communication link with the wireless communication device.

In some implementations, the first wireless communication link is a secure peer-to-peer link and the second wireless communication link is a wireless local area network link.

In some implementations, the wireless communication device is a traffic source device, an access point, or a compute device.

Additionally, or alternatively, the wireless communication device may support wireless communication at a wireless communication device in accordance with examples as disclosed herein. In some implementations, the connection setup component 1110 is capable of, configured to, or operable to support a means for receiving, in association with establishing a wireless communication link with a first wearable or handheld wireless device, one or more first packets indicating a shared address corresponding to an association of wearable or handheld wireless devices including at least the first wearable or handheld wireless device and a second wearable or handheld wireless device, a first link identifier corresponding to the first wearable or handheld wireless device, and a second link identifier corresponding to the second wearable or handheld wireless device. In some implementations, the link ID-based communication component 1115 is capable of, configured to, or operable to support a means for transmitting, in accordance with the shared address, one or more second packets associated with the first link identifier and one or more third packets associated with the second link identifier.

In some implementations, the link ID-based communication component 1115 is capable of, configured to, or operable to support a means for receiving a first indication of the first link identifier via a first packet in association with a first establishment of a first block acknowledgment session between the wireless communication device and the first wearable or handheld wireless device. In some implementations, the link ID-based communication component 1115 is capable of, configured to, or operable to support a means for receiving a second indication of the second link identifier via a second packet in association with a second establishment of a second block acknowledgment session between the wireless communication device and the second wearable or handheld wireless device.

In some implementations, the link ID-based communication component 1115 is capable of, configured to, or operable to support a means for transmitting first information indicative of a first schedule of first communication time intervals corresponding to the first link identifier, where transmitting the one or more second packets associated with the first link identifier is associated with the first schedule of the first communication time intervals. In some implementations, the link ID-based communication component 1115 is capable of, configured to, or operable to support a means for transmitting second information indicative of a second schedule of second communication time intervals corresponding to the second link identifier, where transmitting the one or more third packets associated with the second link identifier is associated with the second schedule of the second communication time intervals.

In some implementations, the link ID-based communication component 1115 is capable of, configured to, or operable to support a means for receiving, from the first wearable or handheld wireless device, a packet indicating the shared address and a power management state corresponding to the shared address, where transmitting the one or more second packets and the one or more third packets is associated with the power management state.

In some implementations, the link ID-based communication component 1115 is capable of, configured to, or operable to support a means for transmitting information indicative of a first mapping of the first link identifier to a first wireless communication link and a second mapping of the second link identifier to a second wireless communication link, where the first wireless communication link is associated with a first frequency channel and the second wireless communication link is associated with a second frequency channel different than the first frequency channel.

In some implementations, to support transmitting the one or more second packets and the one or more third packets, the link ID-based communication component 1115 is capable of, configured to, or operable to support a means for transmitting the one or more second packets via the first wireless communication link within a first communication time interval and the one or more third packets via the second wireless communication link within a second communication time interval, where the first communication time interval and the second communication time interval at least partially overlap in time.

In some implementations, the connection setup component 1110 is capable of, configured to, or operable to support a means for transmitting, to the first wearable or handheld wireless device, an indication that the wireless communication device is capable of quality of service-based traffic flow prioritization. In some implementations, the connection setup component 1110 is capable of, configured to, or operable to support a means for establishing the wireless communication link using the shared address in accordance with the wireless communication device being capable of the quality of service-based traffic flow prioritization.

In some implementations, to support transmitting the indication that the wireless communication device is capable of the quality of service-based traffic flow prioritization, the connection setup component 1110 is capable of, configured to, or operable to support a means for transmitting identification information of the wireless communication device, where the identification information indicates that the wireless communication device is present in a first list of devices for which use of the shared address is allowed and absent from a second list of devices for which use of the shared address is not allowed.

In some implementations, a presence of the identification information of the wireless communication device in either the first list of devices or the second list of devices is indicative of a previous quality of service conformance test for the wireless communication device. In some implementations, being present in the first list of devices is indicative of a successful quality of service conformance test and being present in the second list of devices is indicative of an unsuccessful quality of service conformance test.

In some implementations, to support transmitting the indication that the wireless communication device is capable of the quality of service-based traffic flow prioritization, the connection setup component 1110 is capable of, configured to, or operable to support a means for transmitting a packet indicating that an end-to-end path between a traffic source device and the first wearable or handheld wireless device is capable of the quality of service-based traffic flow prioritization, where the wireless communication device is the traffic source device or another wireless communication device along the end-to-end path.

In some implementations, the first link identifier and the second link identifier are association with a same channel access category.

In some implementations, the one or more second packets include indications of a first type of service for the first wearable or handheld wireless device, the first type of service being mapped to the first link identifier, and the one or more third packets include indications of a second type of service for the second wearable or handheld wireless device, the second type of service being mapped to the second link identifier.

In some implementations, each packet of the one or more second packets includes first information that is specific to the first wearable or handheld wireless device and each packet of the one or more third packets includes second information that is specific to the second wearable or handheld wireless device.

In some implementations, each packet of the one or more second packets and the one or more third packets includes both first information that is specific to the first wearable or handheld wireless device and second information that is specific to the second wearable or handheld wireless device.

In some implementations, the one or more first packets include one or more of an authentication frame, an association frame, an address resolution protocol frame, a dynamic host configuration protocol frame, an extensible authentication protocol over local area network frame, a key handshake frame, and an add block acknowledgment frame.

In some implementations, the wireless communication device is a traffic source device.

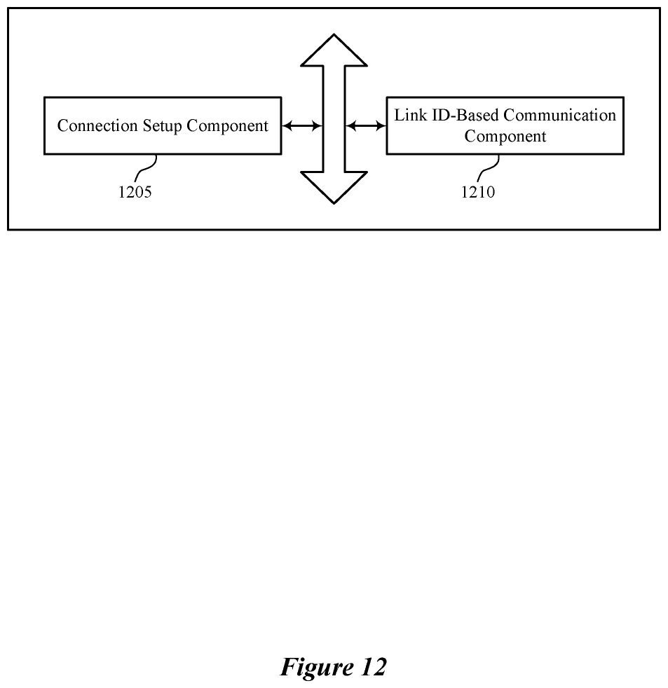

FIG. 12 shows a block diagram of an example wireless communication device that supports managing a group of Wi-Fi-enabled wearable or handheld wireless devices using a shared address. In various examples, the wireless communication device can be a chip, SoC, chipset, package or device that may include: one or more modems (such as, a Wi-Fi (IEEE 802.11) modem or a cellular modem such as 3GPP 4G LTE or 5G compliant modem); one or more processors, processing blocks or processing elements (collectively “at least one processor”); one or more radios (collectively “at least one radio”); and one or more memories or memory blocks (collectively “at least one memory”). In some implementations, the at least one processor may include multiple processors, and the at least one memory may include multiple memories. One or more of the multiple processors may be coupled with one or more of the multiple memories which may, individually or collectively, be configured to perform various functions described herein (as part of a processing system).

In some implementations, the wireless communication device can be a device for use in an AP, a STA, or any other device that may function as a traffic source/sink device, such as AP 102 or a STA 104 as described with reference to FIG. 1 or a wireless communication device 202 as described with reference to FIG. 2. In some other examples, the wireless communication device can be an AP that includes such a chip, SoC, chipset, package or device as well as multiple antennas. The wireless communication device is capable of transmitting and receiving wireless communication in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some implementations, the wireless communication device also includes or can be coupled with at least one application processor which may be further coupled with at least one memory. In some implementations, the wireless communication device further includes at least one external network interface that enables communication with a core network or backhaul network to gain access to external networks including the Internet.

The wireless communication device includes a connection setup component 1205 and a link ID-based communication component 1210. Portions of one or more of the connection setup component 1205 and the link ID-based communication component 1210 may be implemented at least in part in hardware or firmware. For example, one or more of the connection setup component 1205 and the link ID-based communication component 1210 may be implemented at least in part by at least one modem. In some implementations, at least some of the connection setup component 1205 and the link ID-based communication component 1210 are implemented at least in part by at least one processor and as software stored in at least one memory. For example, portions of one or more of the connection setup component 1205 and the link ID-based communication component 1210 can be implemented as non-transitory instructions (or “code”) executable by the at least one processor to perform the functions or operations of the respective module.

In some implementations, the at least one processor may be a component of a processing system. A processing system may generally refer to a system or series of machines or components that receives inputs and processes the inputs to produce a set of outputs (which may be passed to other systems or components of, for example, the wireless communication device). For example, a processing system of the wireless communication device may refer to a system including the various other components or subcomponents of the wireless communication device, such as the at least one processor, or at least one transceiver, or at least one communication manager, or other components or combinations of components of the wireless communication device. The processing system of the wireless communication device may interface with other components of the wireless communication device, and may process information received from other components (such as inputs or signals) or output information to other components. For example, a chip or modem of the wireless communication device may include a processing system, a first interface to output information and a second interface to obtain information. In some implementations, the first interface may refer to an interface between the processing system of the chip or modem and a transmitter, such that the wireless communication device may transmit information output from the chip or modem. In some implementations, the second interface may refer to an interface between the processing system of the chip or modem and a receiver, such that the wireless communication device may obtain information or signal inputs, and the information may be passed to the processing system. A person having ordinary skill in the art will readily recognize that the first interface also may obtain information or signal inputs, and the second interface also may output information or signal outputs.

The wireless communication device may support wireless communication at a wireless communication device in accordance with examples as disclosed herein. The connection setup component 1205 is capable of, configured to, or operable to support a means for receiving, in association with establishing a wireless communication link with a first wearable or handheld wireless device, one or more first packets indicating a shared address corresponding to an association of wearable or handheld wireless devices including at least the first wearable or handheld wireless device and a second wearable or handheld wireless device, a first link identifier corresponding to the first wearable or handheld wireless device, and a second link identifier corresponding to the second wearable or handheld wireless device. The link ID-based communication component 1210 is capable of, configured to, or operable to support a means for transmitting, in accordance with the shared address, one or more second packets associated with the first link identifier and one or more third packets associated with the second link identifier.

In some implementations, the link ID-based communication component 1210 is capable of, configured to, or operable to support a means for receiving a first indication of the first link identifier via a first packet in association with a first establishment of a first block acknowledgment session between the wireless communication device and the first wearable or handheld wireless device. In some implementations, the link ID-based communication component 1210 is capable of, configured to, or operable to support a means for receiving a second indication of the second link identifier via a second packet in association with a second establishment of a second block acknowledgment session between the wireless communication device and the second wearable or handheld wireless device.

In some implementations, the link ID-based communication component 1210 is capable of, configured to, or operable to support a means for transmitting first information indicative of a first schedule of first communication time intervals corresponding to the first link identifier, where transmitting the one or more second packets associated with the first link identifier is associated with the first schedule of the first communication time intervals. In some implementations, the link ID-based communication component 1210 is capable of, configured to, or operable to support a means for transmitting second information indicative of a second schedule of second communication time intervals corresponding to the second link identifier, where transmitting the one or more third packets associated with the second link identifier is associated with the second schedule of the second communication time intervals.

In some implementations, the link ID-based communication component 1210 is capable of, configured to, or operable to support a means for receiving, from the first wearable or handheld wireless device, a packet indicating the shared address and a power management state corresponding to the shared address, where transmitting the one or more second packets and the one or more third packets is associated with the power management state.

In some implementations, the link ID-based communication component 1210 is capable of, configured to, or operable to support a means for transmitting information indicative of a first mapping of the first link identifier to a first wireless communication link and a second mapping of the second link identifier to a second wireless communication link, where the first wireless communication link is associated with a first frequency channel and the second wireless communication link is associated with a second frequency channel different than the first frequency channel.

In some implementations, to support transmitting the one or more second packets and the one or more third packets, the link ID-based communication component 1210 is capable of, configured to, or operable to support a means for transmitting the one or more second packets via the first wireless communication link within a first communication time interval and the one or more third packets via the second wireless communication link within a second communication time interval, where the first communication time interval and the second communication time interval at least partially overlap in time.

In some implementations, the connection setup component 1205 is capable of, configured to, or operable to support a means for transmitting, to the first wearable or handheld wireless device, an indication that the wireless communication device is capable of quality of service-based traffic flow prioritization. In some implementations, the connection setup component 1205 is capable of, configured to, or operable to support a means for establishing the wireless communication link using the shared address in accordance with the wireless communication device being capable of the quality of service-based traffic flow prioritization.

In some implementations, to support transmitting the indication that the wireless communication device is capable of the quality of service-based traffic flow prioritization, the connection setup component 1205 is capable of, configured to, or operable to support a means for transmitting identification information of the wireless communication device, where the identification information indicates that the wireless communication device is present in a first list of devices for which use of the shared address is allowed and absent from a second list of devices for which use of the shared address is not allowed.

In some implementations, a presence of the identification information of the wireless communication device in either the first list of devices or the second list of devices is indicative of a previous quality of service conformance test for the wireless communication device. In some implementations, being present in the first list of devices is indicative of a successful quality of service conformance test and being present in the second list of devices is indicative of an unsuccessful quality of service conformance test.

In some implementations, to support transmitting the indication that the wireless communication device is capable of the quality of service-based traffic flow prioritization, the connection setup component 1205 is capable of, configured to, or operable to support a means for transmitting a packet indicating that an end-to-end path between a traffic source device and the first wearable or handheld wireless device is capable of the quality of service-based traffic flow prioritization, where the wireless communication device is the traffic source device or another wireless communication device along the end-to-end path.

In some implementations, the first link identifier and the second link identifier are association with a same channel access category.

In some implementations, the one or more second packets include indications of a first type of service for the first wearable or handheld wireless device, the first type of service being mapped to the first link identifier, and the one or more third packets include indications of a second type of service for the second wearable or handheld wireless device, the second type of service being mapped to the second link identifier.

In some implementations, each packet of the one or more second packets includes first information that is specific to the first wearable or handheld wireless device and each packet of the one or more third packets includes second information that is specific to the second wearable or handheld wireless device.

In some implementations, each packet of the one or more second packets and the one or more third packets includes both first information that is specific to the first wearable or handheld wireless device and second information that is specific to the second wearable or handheld wireless device.

In some implementations, the one or more first packets include one or more of an authentication frame, an association frame, an address resolution protocol frame, a dynamic host configuration protocol frame, an extensible authentication protocol over local area network frame, a key handshake frame, and an add block acknowledgment frame.

In some implementations, the wireless communication device is a traffic source device.

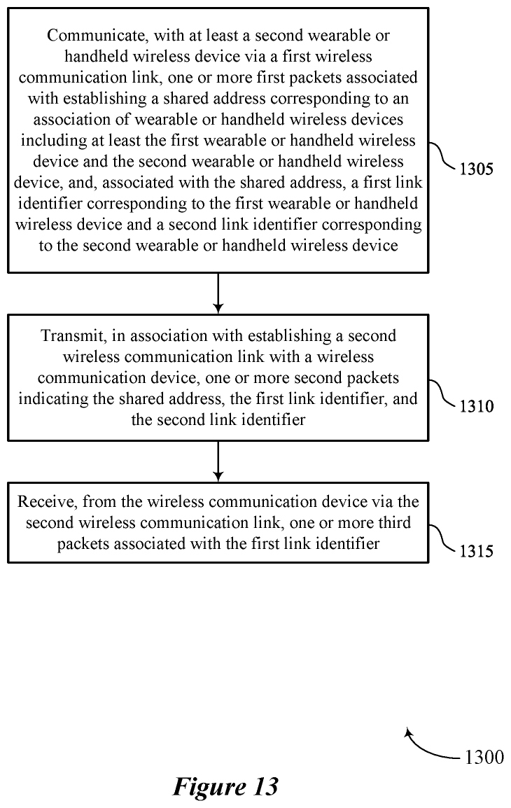

FIG. 13 shows a flowchart illustrating an example process 1300 that supports managing a group of Wi-Fi-enabled wearable or handheld wireless devices using a shared address according to some aspects of the present disclosure. The operations of the process 1300 may be an example of a method implemented by a wearable device or its components. For example, the process 1300 may be performed by a wireless communication device, such as the wireless communication device described with reference to FIG. 11, operating as or within a wireless STA. In some implementations, the process 1300 may be performed by a wireless STA, such as one of the STAs 104 described with reference to FIG. 1.

In some implementations, in block 1305, the wireless STA may communicating, with at least a second wearable or handheld wireless device via a first wireless communication link, one or more first packets associated with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device. The operations of block 1305 may be performed in accordance with examples as disclosed herein. In some implementations, aspects of the operations of block 1305 may be performed by a peer communication component 1105 as described with reference to FIG. 11.

In some implementations, in block 1310, the wireless STA may transmit, in association with establishing a second wireless communication link with a wireless communication device, one or more second packets indicating the shared address, the first link identifier, and the second link identifier. The operations of block 1310 may be performed in accordance with examples as disclosed herein. In some implementations, aspects of the operations of block 1310 may be performed by a connection setup component 1110 as described with reference to FIG. 11.

In some implementations, in block 1315, the wireless STA may receive, from the wireless communication device via the second wireless communication link, one or more third packets associated with the first link identifier. The operations of block 1315 may be performed in accordance with examples as disclosed herein. In some implementations, aspects of the operations of block 1315 may be performed by a link ID-based communication component 1115 as described with reference to FIG. 11.

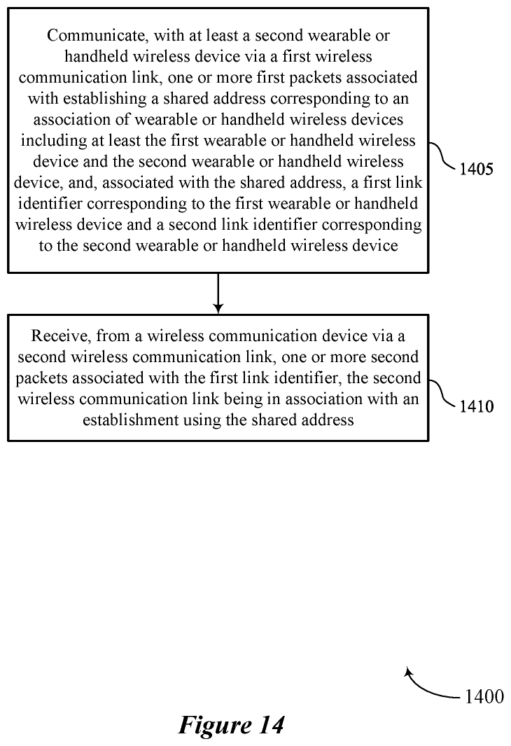

FIG. 14 shows a flowchart illustrating an example process 1400 that supports managing a group of Wi-Fi-enabled wearable or handheld wireless devices using a shared address according to some aspects of the present disclosure. The operations of the process 1400 may be an example of a method implemented by a wearable device or its components. For example, the process 1400 may be performed by a wireless communication device, such as the wireless communication device described with reference to FIG. 11, operating as or within a wireless STA. In some implementations, the process 1400 may be performed by a wireless STA, such as one of the STAs 104 described with reference to FIG. 1.

In some implementations, in block 1405, the wireless STA may communicating, with at least a second wearable or handheld wireless device via a first wireless communication link, one or more first packets associated with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device. The operations of block 1405 may be performed in accordance with examples as disclosed herein. In some implementations, aspects of the operations of block 1405 may be performed by a peer communication component 1105 as described with reference to FIG. 11.

In some implementations, in block 1410, the wireless STA may receive, from a wireless communication device via a second wireless communication link, one or more second packets associated with the first link identifier, the second wireless communication link being in association with an establishment using the shared address. The operations of block 1410 may be performed in accordance with examples as disclosed herein. In some implementations, aspects of the operations of block 1410 may be performed by a link ID-based communication component 1115 as described with reference to FIG. 11.

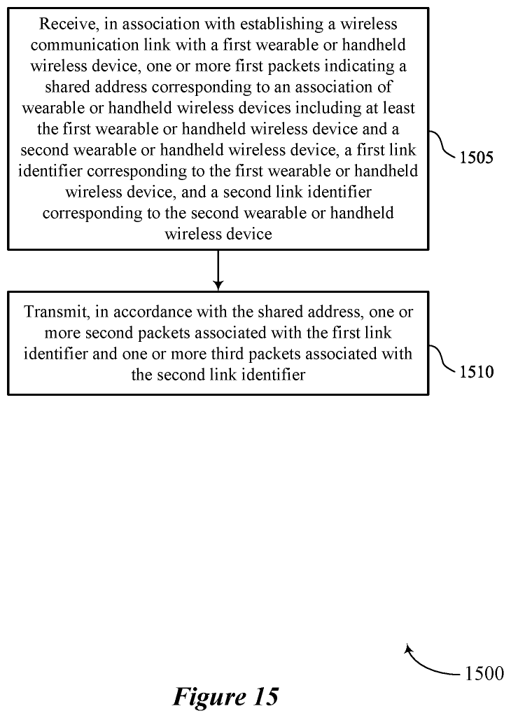

FIG. 15 shows a flowchart illustrating an example process 1500 that supports managing a group of Wi-Fi-enabled wearable or handheld wireless devices using a shared address in accordance with one or more aspects of the present disclosure. The operations of the process 1500 may be implemented by a STA or an AP or its components. For example, the operations of the process 1500 may be performed by a traffic source/sink device as described with reference to FIG. 12. In some implementations, a STA or an AP may execute a set of instructions to control the functional elements of the wireless STA or the wireless AP to perform the described functions. Additionally, or alternatively, the wireless STA or the wireless AP may perform aspects of the described functions using special-purpose hardware.

In some implementations, in block 1505, the wireless STA or the wireless AP may receive, in association with establishing a wireless communication link with a first wearable or handheld wireless device, one or more first packets indicating a shared address corresponding to an association of wearable or handheld wireless devices including at least the first wearable or handheld wireless device and a second wearable or handheld wireless device, a first link identifier corresponding to the first wearable or handheld wireless device, and a second link identifier corresponding to the second wearable or handheld wireless device. The operations of block 1505 may be performed in accordance with examples as disclosed herein. In some implementations, aspects of the operations of block 1505 may be performed by a connection setup component 1205 as described with reference to FIG. 12.

In some implementations, in block 1510, the wireless STA or the wireless AP may transmit, in accordance with the shared address, one or more second packets associated with the first link identifier and one or more third packets associated with the second link identifier. The operations of block 1510 may be performed in accordance with examples as disclosed herein. In some implementations, aspects of the operations of block 1510 may be performed by a link ID-based communication component 1210 as described with reference to FIG. 12.

Implementation examples are described in the following numbered clauses:

Clause 1: A method for wireless communication at a first wearable or handheld wireless device, including: communicating, with at least a second wearable or handheld wireless device via a first wireless communication link, one or more first packets associated with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device; transmitting, in association with establishing a second wireless communication link with a wireless communication device, one or more second packets indicating the shared address, the first link identifier, and the second link identifier; and receiving, from the wireless communication device via the second wireless communication link, one or more third packets associated with the first link identifier.

Clause 2: The method of clause 1, where communicating the one or more first packets with at least the second wearable or handheld wireless device via the first wireless communication link includes: transmitting one or more of the one or more first packets to, and receiving one or more of the one or more first packets from, the second wearable or handheld wireless device in accordance with a negotiation of the shared address with the second wearable or handheld wireless device.

Clause 3: The method of any of clauses 1 through 2, where communicating the one or more first packets with at least the second wearable or handheld wireless device via the first wireless communication link includes: transmitting one or more of the one or more first packets to, and receiving one or more of the one or more first packets from, the second wearable or handheld wireless device in accordance with an assignment of the first link identifier to the first wearable or handheld wireless device and the second link identifier to the second wearable or handheld wireless device.

Clause 4: The method of any of clauses 1 through 3, further including: transmitting, to the wireless communication device, a fourth packet in association with an establishment of a first block acknowledgment session between the wireless communication device and the first wearable or handheld wireless device, the fourth packet including an indication of the first link identifier; and transmitting, to the wireless communication device, one or more block acknowledgments associated with the one or more third packets.

Clause 5: The method of any of clauses 1 through 4, further including: transmitting, to the wireless communication device, a fourth packet indicating the shared address and a power management state corresponding to the shared address.

Clause 6: The method of clause 5, further including: receiving, from the second wearable or handheld wireless device via the first wireless communication link, a fifth packet indicating that the second wearable or handheld wireless device is in the power management state, where transmitting the fourth packet indicating the power management state is in association with receiving the fifth packet.

Clause 7: The method of any of clauses 1 through 6, further including: communicating, with at least the second wearable or handheld wireless device via the first wireless communication link, one or more fourth packets in accordance with a negotiation of one or more of: one or more security keys associated with communication with the wireless communication device, a dynamic host configuration protocol address, or one or more address resolution protocol tables, where the first wearable or handheld wireless device establishes the second wireless communication link in accordance with the negotiation.

Clause 8: The method of any of clauses 1 through 7, further including: receiving, from the wireless communication device, information indicative of a schedule of communication time intervals corresponding to the first link identifier; and monitoring the second wireless communication link in accordance with the schedule of the communication time intervals, where receiving the one or more third packets is in association with monitoring the second wireless communication link.

Clause 9: The method of any of clauses 1 through 8, where each of the one or more third packets includes a respective frame header indicating the first link identifier, the method further including: decoding data portions of the one or more third packets in accordance with frame headers of the one or more third packets indicating the first link identifier; receiving one or more fourth packets each including a respective frame header indicating the second link identifier; and refraining from decoding data portions of the one or more fourth packets in accordance with frame headers of the one or more fourth packets indicating the second link identifier.

Clause 10: The method of any of clauses 1 through 9, further including: receiving, from the wireless communication device, information indicative of a first mapping of the first link identifier to the second wireless communication link and a second mapping of the second link identifier to a third wireless communication link; and tuning at least one radio to the second wireless communication link in accordance with the first mapping, where receiving the one or more third packets is in association with tuning the at least one radio to the second wireless communication link, and where the second wireless communication link is associated with a first frequency channel and the third wireless communication link is associated with a second frequency channel different than the first frequency channel.

Clause 11: The method of any of clauses 1 through 10, further including: receiving an indication that the wireless communication device is capable of quality of service-based traffic flow prioritization; and establishing the second wireless communication link with the wireless communication device using the shared address in accordance with the wireless communication device being capable of the quality of service-based traffic flow prioritization.

Clause 12: The method of clause 11, where receiving the indication that the wireless communication device is capable of the quality of service-based traffic flow prioritization includes: receiving identification information of the wireless communication device, where the identification information indicates that the wireless communication device is present in a first list of devices for which use of the shared address is allowed and absent from a second list of devices for which use of the shared address is not allowed.

Clause 13: The method of clause 12, where a presence of the identification information of the wireless communication device in either the first list of devices or the second list of devices is indicative of a previous quality of service conformance test for the wireless communication device, being present in the first list of devices is indicative of a successful quality of service conformance test and being present in the second list of devices is indicative of an unsuccessful quality of service conformance test.

Clause 14: The method of any of clauses 11 through 13, where receiving the indication that the wireless communication device is capable of the quality of service-based traffic flow prioritization includes: receiving a packet indicating that an end-to-end path between a traffic source device and the first wearable or handheld wireless device is capable of the quality of service-based traffic flow prioritization, where the wireless communication device is the traffic source device or another wireless communication device along the end-to-end path.

Clause 15: The method of any of clauses 1 through 14, further including: communicating, with the second wearable or handheld wireless device via the first wireless communication link, information indicative of one or more link quality metrics pertaining to first communication between the first wearable or handheld wireless device and the wireless communication device and second communication between the second wearable or handheld wireless device and the wireless communication device.

Clause 16: The method of clause 15, further including: receiving an indication that a link quality metric pertaining to the second communication between the second wearable or handheld wireless device and the wireless communication device fails to satisfy a condition; receiving one or more fourth packets including the second link identifier in accordance with the link quality metric failing to satisfy the condition; and transmitting, to the second wearable or handheld wireless device via the first wireless communication link, data received via the one or more fourth packets in accordance with the one or more fourth packets including the second link identifier.

Clause 17: The method of clause 16, further including: receiving, from the second wearable or handheld wireless device via the first wireless communication link, feedback information associated with the data; and transmitting, to the wireless communication device, one or more block acknowledgments associated with the one or more fourth packets, the one or more block acknowledgments indicating the feedback information received from the second wearable or handheld wireless device.

Clause 18: The method of any of clauses 16 through 17, further including: receiving an indication that the link quality metric pertaining to the second communication between the second wearable or handheld wireless device and the wireless communication device satisfies the condition; and refraining from decoding any packets including the second link identifier in accordance with the link quality metric satisfying the condition, where the first wearable or handheld wireless device temporarily receives the one or more fourth packets including the second link identifier while the link quality metric fails to satisfy the condition.

Clause 19: The method of any of clauses 16 through 18, further including: transmitting, to the wireless communication device in accordance with the link quality metric failing to satisfy the condition, information indicative of a recommended coding rate.

Clause 20: The method of clause 19, where the recommended coding rate is for both the first communication between the first wearable or handheld wireless device and the wireless communication device and the second communication between the second wearable or handheld wireless device and the wireless communication device.

Clause 21: The method of any of clauses 15 through 20, further including: transmitting an indication that a link quality metric pertaining to the first communication between the first wearable or handheld wireless device and the wireless communication device fails to satisfy a condition; receiving data from the second wearable or handheld wireless device via the first wireless communication link in accordance with the link quality metric failing to satisfy the condition; and transmitting, to the second wearable or handheld wireless device via the first wireless communication link, feedback information associated with the data.

Clause 22: The method of clause 21, further including: transmitting an indication that the link quality metric pertaining to the first communication between the first wearable or handheld wireless device and the wireless communication device satisfies the condition; and receiving, via the second wireless communication link, packets including the first link identifier in accordance with the link quality metric satisfying the condition, where reception of any packets via the second wireless communication link is temporarily paused while the link quality metric fails to satisfy the condition.

Clause 23: The method of any of clauses 1 through 22, further including: receiving an indication of a handover of the first wearable or handheld wireless device from the wireless communication device to a second wireless communication device; receiving an indication that the second wireless communication device is incapable of quality of service-based traffic flow prioritization; and transmitting, in association with establishing a third wireless communication link with the second wireless communication device, one or more fourth packets indicating a device-specific address, the third wireless communication link being exclusively for the first wearable or handheld wireless device in accordance with the one or more fourth packets indicating the device-specific address.

Clause 24: The method of any of clauses 1 through 23, where the first link identifier and the second link identifier are associated with a same channel access category.

Clause 25: The method of any of clauses 1 through 24, where the one or more third packets include indications of a first type of service for the first wearable or handheld wireless device, the first type of service being mapped to the first link identifier.

Clause 26: The method of any of clauses 1 through 25, where the one or more second packets include one or more of an authentication frame, an association frame, an address resolution protocol frame, a dynamic host configuration protocol frame, an extensible authentication protocol over local area network frame, a key handshake frame, and an add block acknowledgment frame.

Clause 27: The method of any of clauses 1 through 26, where communication of the one or more first packets with the second wearable or handheld wireless device indicates, to the second wearable or handheld wireless device, to refrain from separately establishing a wireless communication link with the wireless communication device.

Clause 28: The method of any of clauses 1 through 27, where the first wireless communication link is a secure peer-to-peer link and the second wireless communication link is a wireless local area network link.

Clause 29: The method of any of clauses 1 through 28, where the wireless communication device is a traffic source device, an access point, or a compute device.

Clause 30: A method for wireless communication at a first wearable or handheld wireless device, including: communicating, with at least a second wearable or handheld wireless device via a first wireless communication link, one or more first packets associated with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device; and receiving, from a wireless communication device via a second wireless communication link, one or more second packets associated with the first link identifier, the second wireless communication link being in association with an establishment using the shared address.

Clause 31: The method of clause 30, where communicating the one or more first packets with at least the second wearable or handheld wireless device via the first wireless communication link includes: transmitting one or more of the one or more first packets to, and receiving one or more of the one or more first packets from, the second wearable or handheld wireless device in accordance with a negotiation of the shared address with the second wearable or handheld wireless device.

Clause 32: The method of any of clauses 30 through 31, where communicating the one or more first packets with at least the second wearable or handheld wireless device via the first wireless communication link includes: transmitting one or more of the one or more first packets to, and receiving one or more of the one or more first packets from, the second wearable or handheld wireless device in accordance with an assignment of the first link identifier to the first wearable or handheld wireless device and the second link identifier to the second wearable or handheld wireless device.

Clause 33: The method of any of clauses 30 through 32, further including: transmitting, to the wireless communication device, a third packet in association with an establishment of a first block acknowledgment session between the wireless communication device and the first wearable or handheld wireless device, the third packet including an indication of the first link identifier; and transmitting, to the wireless communication device, one or more block acknowledgments associated with the one or more second packets.

Clause 34: The method of any of clauses 30 through 33, further including: communicating, with at least the second wearable or handheld wireless device via the first wireless communication link, one or more third packets in accordance with a negotiation of one or more of: one or more security keys associated with communication with the wireless communication device, a dynamic host configuration protocol address, or one or more address resolution protocol tables, where the second wearable or handheld wireless device establishes the second wireless communication link in accordance with the negotiation.

Clause 35: The method of any of clauses 30 through 34, further including: receiving, from the wireless communication device, information indicative of a schedule of communication time intervals corresponding to the first link identifier; and monitoring the second wireless communication link in accordance with the schedule of the communication time intervals, where receiving the one or more second packets is in association with monitoring the second wireless communication link.

Clause 36: The method of any of clauses 30 through 35, where each of the one or more second packets includes a respective frame header indicating the first link identifier, the method further including: decoding data portions of the one or more second packets in accordance with frame headers of the one or more second packets indicating the first link identifier; receiving one or more third packets each including a respective frame header indicating the second link identifier; and refraining from decoding data portions of the one or more third packets in accordance with frame headers of the one or more third packets indicating the second link identifier.

Clause 37: The method of any of clauses 30 through 36, further including: receiving, from the wireless communication device, information indicative of a first mapping of the first link identifier to the second wireless communication link and a second mapping of the second link identifier to a third link; and tuning at least one radio to the second wireless communication link in accordance with the first mapping, where receiving the one or more second packets is in association with tuning the at least one radio to the second wireless communication link, and where the second wireless communication link is associated with a first frequency channel and the third link is associated with a second frequency channel different than the first frequency channel.

Clause 38: The method of any of clauses 30 through 37, further including: communicating, with the second wearable or handheld wireless device via the first wireless communication link, information indicative of one or more link quality metrics pertaining to first communication between the first wearable or handheld wireless device and the wireless communication device and second communication between the second wearable or handheld wireless device and the wireless communication device.

Clause 39: The method of clause 38, further including: receiving an indication that a link quality metric pertaining to the second communication between the second wearable or handheld wireless device and the wireless communication device fails to satisfy a condition; receiving one or more third packets including the second link identifier in accordance with the link quality metric failing to satisfy the condition; and transmitting, to the second wearable or handheld wireless device via the first wireless communication link, data received via the one or more third packets in accordance with the one or more third packets including the second link identifier.

Clause 40: The method of clause 39, further including: receiving, from the second wearable or handheld wireless device via the first wireless communication link, feedback information associated with the data; and transmitting, to the wireless communication device, one or more block acknowledgments associated with the one or more third packets, the one or more block acknowledgments indicating the feedback information received from the second wearable or handheld wireless device.

Clause 41: The method of any of clauses 39 through 40, further including: receiving an indication that the link quality metric pertaining to the second communication between the second wearable or handheld wireless device and the wireless communication device satisfies the condition; and refraining from decoding any packets including the second link identifier in accordance with the link quality metric satisfying the condition, where the first wearable or handheld wireless device temporarily receives the one or more third packets including the second link identifier while the link quality metric fails to satisfy the condition.

Clause 42: The method of any of clauses 39 through 41, further including: transmitting, to the wireless communication device in accordance with the link quality metric failing to satisfy the condition, information indicative of a recommended coding rate.

Clause 43: The method of clause 42, where the recommended coding rate is for both the first communication between the first wearable or handheld wireless device and the wireless communication device and the second communication between the second wearable or handheld wireless device and the wireless communication device.

Clause 44: The method of any of clauses 38 through 43, further including: transmitting an indication that a link quality metric pertaining to the first communication between the first wearable or handheld wireless device and the wireless communication device fails to satisfy a condition; receiving data from the second wearable or handheld wireless device via the first wireless communication link in accordance with the link quality metric failing to satisfy the condition; and transmitting, to the second wearable or handheld wireless device via the first wireless communication link, feedback information associated with the data.

Clause 45: The method of clause 44, further including: transmitting an indication that the link quality metric pertaining to the first communication between the first wearable or handheld wireless device and the wireless communication device satisfies the condition; and receiving, via the second wireless communication link, packets including the first link identifier in accordance with the link quality metric satisfying the condition, where reception of any packets via the second wireless communication link is temporarily paused while the link quality metric fails to satisfy the condition.

Clause 46: The method of any of clauses 30 through 45, further including: receiving an indication of a handover, of the association of the wearable or handheld wireless devices including at least the first wearable or handheld wireless device and the second wearable or handheld wireless device, from the wireless communication device to a second wireless communication device; receiving an indication that the second wireless communication device is incapable of quality of service-based traffic flow prioritization; and transmitting, in association with establishing a third wireless communication link with the second wireless communication device, one or more third packets indicating a device-specific address, the third wireless communication link being exclusively for the first wearable or handheld wireless device in accordance with the one or more third packets indicating the device-specific address.

Clause 47: The method of any of clauses 30 through 46, where the first link identifier and the second link identifier are associated with a same channel access category.

Clause 48: The method of any of clauses 30 through 47, where the one or more second packets include indications of a first type of service for the first wearable or handheld wireless device, the first type of service being mapped to the first link identifier.

Clause 49: The method of any of clauses 30 through 48, where communication of the one or more first packets with the second wearable or handheld wireless device indicates, to the first wearable or handheld wireless device, to refrain from separately establishing a wireless communication link with the wireless communication device.

Clause 50: The method of any of clauses 30 through 49, where the first wireless communication link is a secure peer-to-peer link and the second wireless communication link is a wireless local area network link.

Clause 51: The method of any of clauses 30 through 50, where the wireless communication device is a traffic source device, an access point, or a compute device.

Clause 52: A method for wireless communication at a wireless communication device, including: receiving, in association with establishing a wireless communication link with a first wearable or handheld wireless device, one or more first packets indicating a shared address corresponding to an association of wearable or handheld wireless devices including at least the first wearable or handheld wireless device and a second wearable or handheld wireless device, a first link identifier corresponding to the first wearable or handheld wireless device, and a second link identifier corresponding to the second wearable or handheld wireless device; and transmitting, in accordance with the shared address, one or more second packets associated with the first link identifier and one or more third packets associated with the second link identifier.

Clause 53: The method of clause 52, further including: receiving a first indication of the first link identifier via a first packet in association with a first establishment of a first block acknowledgment session between the wireless communication device and the first wearable or handheld wireless device; and receiving a second indication of the second link identifier via a second packet in association with a second establishment of a second block acknowledgment session between the wireless communication device and the second wearable or handheld wireless device.

Clause 54: The method of any of clauses 52 through 53, further including: transmitting first information indicative of a first schedule of first communication time intervals corresponding to the first link identifier, where transmitting the one or more second packets associated with the first link identifier is associated with the first schedule of the first communication time intervals; and transmitting second information indicative of a second schedule of second communication time intervals corresponding to the second link identifier, where transmitting the one or more third packets associated with the second link identifier is associated with the second schedule of the second communication time intervals.

Clause 55: The method of any of clauses 52 through 54, further including: receiving, from the first wearable or handheld wireless device, a packet indicating the shared address and a power management state corresponding to the shared address, where transmitting the one or more second packets and the one or more third packets is associated with the power management state.

Clause 56: The method of any of clauses 52 through 55, further including: transmitting information indicative of a first mapping of the first link identifier to a first wireless communication link and a second mapping of the second link identifier to a second wireless communication link, where the first wireless communication link is associated with a first frequency channel and the second wireless communication link is associated with a second frequency channel different than the first frequency channel.

Clause 57: The method of clause 56, where transmitting the one or more second packets and the one or more third packets includes: transmitting the one or more second packets via the first wireless communication link within a first communication time interval and the one or more third packets via the second wireless communication link within a second communication time interval, where the first communication time interval and the second communication time interval at least partially overlap in time.

Clause 58: The method of any of clauses 52 through 57, further including: transmitting, to the first wearable or handheld wireless device, an indication that the wireless communication device is capable of quality of service-based traffic flow prioritization; and establishing the wireless communication link using the shared address in accordance with the wireless communication device being capable of the quality of service-based traffic flow prioritization.

Clause 59: The method of clause 58, where transmitting the indication that the wireless communication device is capable of the quality of service-based traffic flow prioritization includes: transmitting identification information of the wireless communication device, where the identification information indicates that the wireless communication device is present in a first list of devices for which use of the shared address is allowed and absent from a second list of devices for which use of the shared address is not allowed.

Clause 60: The method of clause 59, where a presence of the identification information of the wireless communication device in either the first list of devices or the second list of devices is indicative of a previous quality of service conformance test for the wireless communication device, being present in the first list of devices is indicative of a successful quality of service conformance test and being present in the second list of devices is indicative of an unsuccessful quality of service conformance test.

Clause 61: The method of any of clauses 58 through 60, where transmitting the indication that the wireless communication device is capable of the quality of service-based traffic flow prioritization includes: transmitting a packet indicating that an end-to-end path between a traffic source device and the first wearable or handheld wireless device is capable of the quality of service-based traffic flow prioritization, where the wireless communication device is the traffic source device or another wireless communication device along the end-to-end path.

Clause 62: The method of any of clauses 52 through 61, where the first link identifier and the second link identifier are association with a same channel access category.

Clause 63: The method of any of clauses 52 through 62, where the one or more second packets include indications of a first type of service for the first wearable or handheld wireless device, the first type of service being mapped to the first link identifier, and the one or more third packets include indications of a second type of service for the second wearable or handheld wireless device, the second type of service being mapped to the second link identifier.

Clause 64: The method of any of clauses 52 through 63, where each packet of the one or more second packets includes first information that is specific to the first wearable or handheld wireless device and each packet of the one or more third packets includes second information that is specific to the second wearable or handheld wireless device.

Clause 65: The method of any of clauses 52 through 64, where each packet of the one or more second packets and the one or more third packets includes both first information that is specific to the first wearable or handheld wireless device and second information that is specific to the second wearable or handheld wireless device.

Clause 66: The method of any of clauses 52 through 65, where the one or more first packets include one or more of an authentication frame, an association frame, an address resolution protocol frame, a dynamic host configuration protocol frame, an extensible authentication protocol over local area network frame, a key handshake frame, and an add block acknowledgment frame.

Clause 67: The method of any of clauses 52 through 66, where the wireless communication device is a traffic source device.

Clause 68: A first wearable or handheld wireless device, including a processing system that includes processor circuitry and memory circuitry that stores code, the processing system configuring to cause the first wearable or handheld wireless device to perform a method of any of clauses 1 through 29.

Clause 69: An apparatus for wireless communication at a first wearable or handheld wireless device, including at least one means for performing a method of any of clauses 1 through 29.

Clause 70: A non-transitory computer-readable medium storing code for wireless communication at a first wearable or handheld wireless device, the code including instructions executable by one or more processors individually or collectively to perform a method of any of clauses 1 through 29.

Clause 71: A first wearable or handheld wireless device, including a processing system that includes processor circuitry and memory circuitry that stores code, the processing system configuring to cause the first wearable or handheld wireless device to perform a method of any of clauses 30 through 51.

Clause 72: An apparatus for wireless communication at a first wearable or handheld wireless device, including at least one means for performing a method of any of clauses 30 through 51.

Clause 73: A non-transitory computer-readable medium storing code for wireless communication at a first wearable or handheld wireless device, the code including instructions executable by one or more processors individually or collectively to perform a method of any of clauses 30 through 51.

Clause 74: A wireless communication device, including a processing system that includes processor circuitry and memory circuitry that stores code, the processing system configuring to cause the wireless communication to perform a method of any of clauses 52 through 67.

Clause 75: An apparatus for wireless communication at a wireless communication device, including at least one means for performing a method of any of clauses 52 through 67.

Clause 76: A non-transitory computer-readable medium storing code for wireless communication at a wireless communication device, the code including instructions executable by one or more processors individually or collectively to perform a method of any of clauses 52 through 67.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, or measuring. Also, “determining” can include receiving (such as receiving information), accessing (such as accessing data stored in memory), or transmitting (such as transmitting information). Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wearable or handheld wireless device, comprising:
a processing system that includes processor circuitry and memory circuitry that stores code, the processing system configured to cause the first wearable or handheld wireless device to:
communicate, with at least a second wearable or handheld wireless device via a first wireless communication link, one or more first packets associated with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device;
transmit, in association with establishing a second wireless communication link with a wireless communication device, one or more second packets indicating the shared address, the first link identifier, and the second link identifier; and
receive, from the wireless communication device via the second wireless communication link, one or more third packets associated with the first link identifier.

2. The first wearable or handheld wireless device of claim 1, wherein, to communicate the one or more first packets with at least the second wearable or handheld wireless device via the first wireless communication link, the processing system is further configured to cause the first wearable or handheld wireless device to:
transmit one or more of the one or more first packets to, and receiving one or more of the one or more first packets from, the second wearable or handheld wireless device in accordance with a negotiation of the shared address with the second wearable or handheld wireless device.

3. The first wearable or handheld wireless device of claim 1, wherein, to communicate the one or more first packets with at least the second wearable or handheld wireless device via the first wireless communication link, the processing system is further configured to cause the first wearable or handheld wireless device to:
transmit one or more of the one or more first packets to, and receiving one or more of the one or more first packets from, the second wearable or handheld wireless device in accordance with an assignment of the first link identifier to the first wearable or handheld wireless device and the second link identifier to the second wearable or handheld wireless device.

4. The first wearable or handheld wireless device of claim 1, wherein the processing system is further configured to cause the first wearable or handheld wireless device to:
transmit, to the wireless communication device, a fourth packet in association with an establishment of a first block acknowledgment session between the wireless communication device and the first wearable or handheld wireless device, the fourth packet including an indication of the first link identifier; and
transmit, to the wireless communication device, one or more block acknowledgments associated with the one or more third packets.

5. The first wearable or handheld wireless device of claim 1, wherein the processing system is further configured to cause the first wearable or handheld wireless device to:
transmit, to the wireless communication device, a fourth packet indicating the shared address and a power management state corresponding to the shared address.

6. The first wearable or handheld wireless device of claim 5, wherein the processing system is further configured to cause the first wearable or handheld wireless device to:
receive, from the second wearable or handheld wireless device via the first wireless communication link, a fifth packet indicating that the second wearable or handheld wireless device is in the power management state, wherein transmitting the fourth packet indicating the power management state is in association with receiving the fifth packet.

7. The first wearable or handheld wireless device of claim 1, wherein the processing system is further configured to cause the first wearable or handheld wireless device to:
communicate, with at least the second wearable or handheld wireless device via the first wireless communication link, one or more fourth packets in accordance with a negotiation of one or more of: one or more security keys associate with communication with the wireless communication device, a dynamic host configuration protocol address, or one or more address resolution protocol tables, wherein the first wearable or handheld wireless device establishes the second wireless communication link in accordance with the negotiation.

8. The first wearable or handheld wireless device of claim 1, wherein the processing system is further configured to cause the first wearable or handheld wireless device to:
receive, from the wireless communication device, information indicative of a schedule of communication time intervals corresponding to the first link identifier; and
monitor the second wireless communication link in accordance with the schedule of the communication time intervals, wherein receiving the one or more third packets is in association with monitoring the second wireless communication link.

9. The first wearable or handheld wireless device of claim 1, wherein each of the one or more third packets includes a respective frame header indicating the first link identifier, and the processing system is further configured to cause the first wearable or handheld wireless device to:
decode data portions of the one or more third packets in accordance with frame headers of the one or more third packets indicating the first link identifier;
receive one or more fourth packets each including a respective frame header indicating the second link identifier; and
refrain from decoding data portions of the one or more fourth packets in accordance with frame headers of the one or more fourth packets indicating the second link identifier.

10. The first wearable or handheld wireless device of claim 1, wherein the processing system is further configured to cause the first wearable or handheld wireless device to:
receive, from the wireless communication device, information indicative of a first mapping of the first link identifier to the second wireless communication link and a second mapping of the second link identifier to a third wireless communication link; and
tune at least one radio to the second wireless communication link in accordance with the first mapping, wherein receiving the one or more third packets is in association with tuning the at least one radio to the second wireless communication link, and wherein the second wireless communication link is associated with a first frequency channel and the third wireless communication link is associated with a second frequency channel different than the first frequency channel.

11. The first wearable or handheld wireless device of claim 1, wherein the processing system is further configured to cause the first wearable or handheld wireless device to:
receive an indication that the wireless communication device is capable of quality of service-based traffic flow prioritization; and
establish the second wireless communication link with the wireless communication device using the shared address in accordance with the wireless communication device being capable of the quality of service-based traffic flow prioritization.

12. The first wearable or handheld wireless device of claim 11, wherein, to receive the indication that the wireless communication device is capable of the quality of service-based traffic flow prioritization, the processing system is further configured to cause the first wearable or handheld wireless device to:
receive identification information of the wireless communication device, wherein the identification information indicates that the wireless communication device is present in a first list of devices for which use of the shared address is allowed and absent from a second list of devices for which use of the shared address is not allowed.

13. The first wearable or handheld wireless device of claim 12, wherein a presence of the identification information of the wireless communication device in either the first list of devices or the second list of devices is indicative of a previous quality of service conformance test for the wireless communication device, wherein being present in the first list of devices is indicative of a successful quality of service conformance test and being present in the second list of devices is indicative of an unsuccessful quality of service conformance test.

14. The first wearable or handheld wireless device of claim 11, wherein, to receive the indication that the wireless communication device is capable of the quality of service-based traffic flow prioritization, the processing system is further configured to cause the first wearable or handheld wireless device to:
receive a packet indicating that an end-to-end path between a traffic source device and the first wearable or handheld wireless device is capable of the quality of service-based traffic flow prioritization, wherein the wireless communication device is the traffic source device or another wireless communication device along the end-to-end path.

15. The first wearable or handheld wireless device of claim 1, wherein the one or more second packets include one or more of an authentication frame, an association frame, an address resolution protocol frame, a dynamic host configuration protocol frame, an extensible authentication protocol over local area network frame, a key handshake frame, and an add block acknowledgment frame.

16. A first wearable or handheld wireless device, comprising:
a processing system that includes processor circuitry and memory circuitry that stores code, the processing system configured to cause the first wearable or handheld wireless device to:
communicate, with at least a second wearable or handheld wireless device via a first wireless communication link, one or more first packets associated with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device; and
receive, from a wireless communication device via a second wireless communication link, one or more second packets associated with the first link identifier, the second wireless communication link being in association with an establishment using the shared address.

17. The first wearable or handheld wireless device of claim 16, wherein the processing system is further configured to cause the first wearable or handheld wireless device to:
communicate, with the second wearable or handheld wireless device via the first wireless communication link, information indicative of one or more link quality metrics pertaining to first communication between the first wearable or handheld wireless device and the wireless communication device and second communication between the second wearable or handheld wireless device and the wireless communication device.

18. The first wearable or handheld wireless device of claim 17, wherein the processing system is further configured to cause the first wearable or handheld wireless device to:
receive an indication that a link quality metric pertaining to the second communication between the second wearable or handheld wireless device and the wireless communication device fails to satisfy a condition;
receive one or more third packets including the second link identifier in accordance with the link quality metric failing to satisfy the condition; and
transmit, to the second wearable or handheld wireless device via the first wireless communication link, data received via the one or more third packets in accordance with the one or more third packets including the second link identifier.

19. The first wearable or handheld wireless device of claim 18, wherein the processing system is further configured to cause the first wearable or handheld wireless device to:
receive, from the second wearable or handheld wireless device via the first wireless communication link, feedback information associated with the data; and
transmit, to the wireless communication device, one or more block acknowledgments associated with the one or more third packets, the one or more block acknowledgments indicating the feedback information received from the second wearable or handheld wireless device.

20. The first wearable or handheld wireless device of claim 18, wherein the processing system is further configured to cause the first wearable or handheld wireless device to:
receive an indication that the link quality metric pertaining to the second communication between the second wearable or handheld wireless device and the wireless communication device satisfies the condition; and
refrain from decoding any packets including the second link identifier in accordance with the link quality metric satisfying the condition, wherein the first wearable or handheld wireless device temporarily receives the one or more third packets including the second link identifier while the link quality metric fails to satisfy the condition.

21. The first wearable or handheld wireless device of claim 18, wherein the processing system is further configured to cause the first wearable or handheld wireless device to:
transmit, to the wireless communication device in accordance with the link quality metric failing to satisfy the condition, information indicative of a recommended coding rate.

22. The first wearable or handheld wireless device of claim 21, wherein the recommended coding rate is for both the first communication between the first wearable or handheld wireless device and the wireless communication device and the second communication between the second wearable or handheld wireless device and the wireless communication device.

23. The first wearable or handheld wireless device of claim 17, wherein the processing system is further configured to cause the first wearable or handheld wireless device to:
transmit an indication that a link quality metric pertaining to the first communication between the first wearable or handheld wireless device and the wireless communication device fails to satisfy a condition;
receive data from the second wearable or handheld wireless device via the first wireless communication link in accordance with the link quality metric failing to satisfy the condition; and
transmit, to the second wearable or handheld wireless device via the first wireless communication link, feedback information associated with the data.

24. The first wearable or handheld wireless device of claim 23, wherein the processing system is further configured to cause the first wearable or handheld wireless device to:
transmit an indication that the link quality metric pertaining to the first communication between the first wearable or handheld wireless device and the wireless communication device satisfies the condition; and
receive, via the second wireless communication link, packets including the first link identifier in accordance with the link quality metric satisfying the condition, wherein reception of any packets via the second wireless communication link is temporarily paused while the link quality metric fails to satisfy the condition.

25. The first wearable or handheld wireless device of claim 16, wherein the processing system is further configured to cause the first wearable or handheld wireless device to:
receive an indication of a handover, of the association of the wearable or handheld wireless devices including at least the first wearable or handheld wireless device and the second wearable or handheld wireless device, from the wireless communication device to a second wireless communication device;
receive an indication that the second wireless communication device is incapable of quality of service-based traffic flow prioritization; and
transmit, in association with establishing a third wireless communication link with the second wireless communication device, one or more third packets indicating a device-specific address, the third wireless communication link being exclusively for the first wearable or handheld wireless device in accordance with the one or more third packets indicating the device-specific address.

26. The first wearable or handheld wireless device of claim 16, wherein the first link identifier and the second link identifier are associated with a same channel access category.

27. A method for wireless communication at a first wearable or handheld wireless device, comprising:
communicating, with at least a second wearable or handheld wireless device via a first wireless communication link, one or more first packets associated with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device;
transmitting, in association with establishing a second wireless communication link with a wireless communication device, one or more second packets indicating the shared address, the first link identifier, and the second link identifier; and
receiving, from the wireless communication device via the second wireless communication link, one or more third packets associated with the first link identifier.

28. The method of claim 27, wherein communicating the one or more first packets with at least the second wearable or handheld wireless device via the first wireless communication link comprises:
transmitting one or more of the one or more first packets to, and receiving one or more of the one or more first packets from, the second wearable or handheld wireless device in accordance with a negotiation of the shared address with the second wearable or handheld wireless device.

29. A method for wireless communication at a first wearable or handheld wireless device, comprising:
communicating, with at least a second wearable or handheld wireless device via a first wireless communication link, one or more first packets associated with establishing a shared address corresponding to an association of wearable or handheld wireless devices including at least the first wearable or handheld wireless device and the second wearable or handheld wireless device, and, associated with the shared address, a first link identifier corresponding to the first wearable or handheld wireless device and a second link identifier corresponding to the second wearable or handheld wireless device; and
receiving, from a wireless communication device via a second wireless communication link, one or more second packets associated with the first link identifier, the second wireless communication link being in association with an establishment using the shared address.

30. The method of claim 29, wherein communicating the one or more first packets with at least the second wearable or handheld wireless device via the first wireless communication link comprises:
transmitting one or more of the one or more first packets to, and receiving one or more of the one or more first packets from, the second wearable or handheld wireless device in accordance with a negotiation of the shared address with the second wearable or handheld wireless device.
